(19) United States
(12) Patent Application Publication
(10) Pub. No.: US 2022/0312803 A1
(43) Pub. Date: Oct. 6, 2022

(54) EDIBLE BARRIER FILM COMPOSITION

(71) Applicant: Apeel Technology, Inc., Goleta, CA (US)

(72) Inventors: Krishnan Chari, Goleta, CA (US); Stanley Zhang, Goleta, CA (US); Ronald C. Bakus, Goleta, CA (US)

(21) Appl. No.: 17/709,048

(22) Filed: Mar. 30, 2022

Related U.S. Application Data
(60) Provisional application No. 63/167,894, filed on Mar. 30, 2021.

(51) Int. Cl. A23L 3/3553; A23L 3/3508; A23B 7/154; A23B 7/16

(52) U.S. Cl. CPC A23L 3/3553; A23L 3/3508; A23B 7/154; A23B 7/16

(57) ABSTRACT

Presented herein are barrier film compositions that can be used, for example, as protective coatings for plant matter (e.g., agricultural products). In some embodiments, the compositions delay moisture loss and/or decrease respiration to extend the shelf life of the plant matter. In one embodiment, the barrier film composition comprises a first component comprising a charged long chain alkyl and a second component having an opposing charge. The barrier film composition can be used to prevent or delay spoilage due to, for instance, desiccation and ripening.

### CROSS-REFERENCE TO RELATED APPLICATION

The application claims the benefit of priority to U.S. Patent Application No. 63/167,894, filed on Mar. 30, 2021, the entire contents of which are hereby incorporated by reference.

### TECHNICAL FIELD

Provided herein are compositions and methods for improving the shelf life of plant matter, for example, by delaying moisture loss and decreasing respiration.

### BACKGROUND

Plant matter, such as agricultural products, can be susceptible to spoilage (e.g., degradation and decomposition). Such degradation and/or decomposition can occur via evaporative moisture loss from an external surface of the plant matter to the atmosphere or respiration (e.g., ripening). Degradation and/or decomposition of plant matter can decrease quality and make the plant mater less desirable. Many types of plant matter have windows of time of ripeness and/or quality. Many types of plant matter have short windows of time when the quality of the plant matter peaks, and/or short windows of availability. Since many agricultural products are seasonal and/or have short windows of time of optimal quality, it may be desirable to delay the degradation and/or decomposition of the plant matter. A delay in degradation and/or decomposition can increase the effective shelf life and/or to make the plant matter available to consumers during times that they would not otherwise be available.

Conventional approaches to prevent degradation, maintain quality, and increase the shelf life of plant matter include special packaging and/or refrigeration. These approaches can be expensive and may require active management. Furthermore, respiration of plant matter is an exothermic process. Heat released during transit and storage requires active cooling of the storage space, which is a major cost driver for shipping companies.

### SUMMARY

Provided herein are compositions for barrier film composition and methods for coating plant matter in a barrier film composition.

Embodiment 1 is a barrier film composition comprising: a first component; and a second component.

Embodiment 2 is the barrier film composition of embodiment 1, wherein: the first component has a first ionic charge and a carbon chain length of C12 to C30, the second component has a second ionic charge opposite in sign to the first ionic charge, and a molar ratio of the first component to the second component is about 1:3 to about 3:1.

Embodiment 3 is the barrier film composition of embodiment 2, wherein the first component is a phosphate.

Embodiment 4 is the barrier film composition of embodiment 3, wherein the phosphate comprises monoalkyl phosphate, dialkyl phosphate, or combinations thereof.

Embodiment 5 is the barrier film composition of embodiment 2, wherein the first component is a fatty acid.

Embodiment 6 is the barrier film composition of embodiment 5, wherein the fatty acid comprises lauric acid, myristic acid, palmitic acid, stearic acid, arachidic acid, oleic acid, or a combination thereof.

Embodiment 7 is the barrier film composition of any one of embodiments 2-6, wherein the second component comprises L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, or a combination thereof.

Embodiment 8 is the barrier film composition of any one of embodiments 2-7, wherein the second component is an ionically charged amino acid.

Embodiment 9 is the barrier film composition of embodiment 8, wherein the amino acid is positively charged.

Embodiment 10 is the barrier film composition of any one of embodiments 2-9, further comprising a nonionic amphiphile.

Embodiment 11 is the barrier film composition of embodiment 10, wherein the nonionic amphiphile has a carbon chain length of C12 to C30.

Embodiment 12 is the barrier film composition of embodiment 10 or embodiment 11, wherein the nonionic amphiphile comprises a monoglyceride.

Embodiment 13 is the barrier film composition of embodiment 1, wherein: the first component comprises a nonionic amphiphile having a carbon chain length of C10-C20, the second component has an ionic charge, and the barrier film composition comprises about 1% w/v to about 15% w/v of the second component.

Embodiment 14 is the barrier film composition of embodiment 13, wherein the first component comprises a monoglyceride.

Embodiment 15 is the barrier film composition of embodiment 13 or embodiment 14, wherein the second component comprises L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, or a combination thereof.

Embodiment 16 is the barrier film composition of any one of embodiments 13-15, wherein the second component is an ionically charged amino acid.

Embodiment 17 is the barrier film composition of embodiment 15 or embodiment 16, wherein the second component comprises L-arginine, L-lysine, L-histidine, or a combination thereof.

Embodiment 18 is a method of making a barrier film composition, the method comprising: combining a first component, a second component, and water to form an aqueous dispersion.

Embodiment 19 is the method of embodiment 18, wherein: the first component has a first ionic charge and a carbon chain length of C12 to C30, the second component has a second ionic charge opposite in sign to the first ionic charge, and a molar ratio of the first component to the second component is about 1:3 to about 3:1.

Embodiment 20 is the method of embodiment 19, wherein the first component is a phosphate.

Embodiment 21 is the method of embodiment 20, wherein the phosphate comprises monoalkyl phosphate, dialkyl phosphate, and hydrogen phosphate or combinations thereof.

Embodiment 22 is the method of embodiment 19, wherein the first component is a fatty acid.

Embodiment 23 is the method of embodiment 22, wherein the fatty acid comprises lauric acid, myristic acid, palmitic acid, stearic acid, arachidic acid, oleic acid, or a combination thereof.

Embodiment 24 is the method of any one of embodiments 19-23, wherein the second component comprises L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, or a combination thereof.

Embodiment 25 is the method of any one of embodiments 19-24, wherein the second component is an ionically charged amino acid.

Embodiment 26 is the method of embodiment 25, wherein the amino acid is positively charged.

Embodiment 27 is the method of any one of embodiments 19-26, further comprising combining a nonionic amphiphile with the first component and the second component.

Embodiment 28 is the method of embodiment 27, wherein the nonionic amphiphile has a carbon chain length of C12 to C30.

Embodiment 29 is the method of embodiment 27 or embodiment 28, wherein the nonionic amphiphile is a monoglyceride.

Embodiment 30 is the method of embodiment 18, wherein the first component comprises a nonionic amphiphile having a carbon chain length of C10-C20, the second component has an ionic charge, and the barrier film composition comprises about 1% w/v to about 15% w/v of the second component.

Embodiment 31 is the method of embodiment 30, wherein the first component comprises a monoglyceride.

Embodiment 32 is the method of embodiment 30 or embodiment 31, wherein the second component comprises L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, or a combination thereof.

Embodiment 33 is the method of any one of embodiments 30-32, wherein the second component comprises an ionically charged amino acid.

Embodiment 34 is the method embodiment 32 or embodiment 33, wherein the second component comprises L-arginine, L-lysine, L-histidine, or a combination thereof

Embodiment 35 is the method of any one of embodiments 19-34, wherein combining comprises blending the first component and the second component with the water for a period of time of about 1 minute to about 4 minutes.

Embodiment 36 is the method of any one of embodiments 19-35, wherein combining comprises heating the water to a temperature of about 70° C. to about 90° C.

Embodiment 37 is a method of forming a barrier film on plant matter, the method comprising: applying a barrier film composition of any one of embodiments 1-17 to a surface of the plant matter.

Embodiment 38 is the method of embodiment 37, wherein applying the barrier film composition to the surface of the plant matter comprises dipping the plant matter in the barrier film composition, or spraying the surface of the plant matter with the barrier film composition.

Embodiment 39 is the method of any one of embodiments 37 or 38, further comprising allowing the barrier film composition to at least partially evaporate for a period time of about 30 seconds to about 180 seconds after applying to the plant matter.

Embodiment 40 is the method of any one of embodiments 37-39, wherein following the application of the composition, the rate of water loss from the plant matter is reduced.

Embodiment 41 is the method of any one of embodiments 37-40, wherein following the application of the composition, the rate of CO2 production by the plant matter is reduced.

Embodiment 42 is the method of any one of embodiments 37-41, wherein following the application of the composition, the rate of mass loss of the plant matter is reduced.

Embodiment 43 is the method of any one of embodiments 37-42, wherein the plant matter comprises a fruit, a vegetable, a leaf, a stem, bark, a seed, a flower, or a combination thereof.

Embodiment 44 is the method of any one of embodiments 37-43, wherein the composition is applied to the plant matter pre-harvest.

Embodiment 45 is the method of any one of embodiments 37-44, wherein the composition is applied to the plant matter post-harvest.

### Definitions

The term “aqueous dispersion” refers to a solvent system that is at least 50% water by molar ratio.

The term “pH modifier” refers to a compound that alters the pH of a composition. The term “nonionic amphiphile” refers to a compound having both a hydrophobic and hydrophilic moiety but lacks a functional group or groups which on addition to a solvent appreciably dissociate or react to form positively and negatively charged components.

The term “charged” means that the molecule has, when excluding the counterion, a net electric charge.

The term “antimicrobial” refers to a compound that inhibits growth of microorganisms, including inhibiting growth of bacteria, fungi, and/or viruses.

As used herein, the “respiration rate” of plant matter refers to the rate at which the plant matter releases CO₂, and more specifically is the volume of CO₂ (at standard temperature and pressure) released per unit time per unit mass of the plant matter. In some embodiments, the respiration rate of plant matter can be measured by placing the product in a closed container of known volume that is equipped with a CO₂ sensor, recording the CO₂ concentration within the container as a function of time, and then calculating the rate of CO₂ release required to obtain the measured concentration values. In some cases, the respiration rate of multiple units of plant matter in a volume (e.g., a sealed or semi-sealed volume) is measured in a single measurement (e.g., as an average). It is understood that respiration rate may be determined by indirect methods, including, but not limited to, hyperspectral imaging and near-infrared spectroscopy (NIR).

As used herein, the term “plant matter” refers to any portion of a plant, including, for example, fruits (in the botanical sense, including fruit peels and juice sacs), vegetables, leaves, stems, barks, seeds, flowers, peels, roots, or oils. Plant matter includes pre-harvested plants or portions thereof as well as post-harvested plants or portions thereof, including, e.g., harvested fruits and vegetables, harvested roots and berries, and picked flowers.

The term “mass loss rate” refers to the rate at which the product loses mass (e.g. by releasing water and other volatile compounds). The mass loss rate is typically expressed as a percentage of the original mass per unit time (e.g. percent per day).

The term “mass loss factor” refers to the ratio of the average mass loss rate of uncoated plant matter (measured for a control group) to the average mass loss rate of the corresponding tested plant matter (e.g., coated plant matter) over a given time. Hence, a larger mass loss factor for a coated plant matter corresponds to a greater reduction in average mass loss rate for the coated plant matter.

As used herein, “fatty acid derivative” is a hydrocarbon chain comprising an ester, acid, or carboxylate group, collectively referred to as “oxycarbonyl moieties”, bonded to one terminus of the hydrocarbon chain, understood to be the “hydrophilic” end; while the opposite terminus is understood to be the “hydrophobic” end. Fatty acid derivatives include fatty acids, fatty acid esters (e.g., monoglycerides), and fatty acid salts.

As used herein, the term “long chain alkyl” is an alkyl containing group having a carbon chain length of C12 to C30.

All publications, patents, patent applications, and information available on the internet and mentioned in this specification are herein incorporated by reference to the same extent as if each individual publication, patent, patent application, or item of information was specifically and individually indicated to be incorporated by reference. To the extent publications, patents, patent applications, and items of information incorporated by reference contradict the disclosure contained in the specification, the specification is intended to supersede and/or take precedence over any such contradictory material.

Where values are described in terms of ranges, it should be understood that the description includes the disclosure of all possible sub-ranges within such ranges, as well as specific numerical values that fall within such ranges irrespective of whether a specific numerical value or specific sub-range is expressly stated.

The term “each,” when used in reference to a collection of items is intended to identify an individual item in the collection but does not necessarily refer to every item in the collection, unless expressly stated otherwise.

### DESCRIPTION OF DRAWINGS

The following drawings illustrate certain embodiments of the features and advantages of this disclosure. These embodiments are not intended to limit the scope of the appended claims in any manner.

FIG. 1 is a plot of mass loss factor of treated (solid data) and untreated (non-solid data) avocados over a period of 5 days.

FIG. 2 is a plot of the CO₂ production rate of treated (solid line) and untreated (broken line) avocados over a period of 5 days.

FIG. 3 is a phase diagram of a barrier film composition comprising lysine, a monoglyceride, and a fatty acid, or a salt or ester thereof.

FIG. 4 is a plot of mass loss factor of untreated avocados (non-solid data) and avocados treated with 10 g/L of 95% w/w glycerol monostearate and 5% w/w lysine in a 1:1 molar ratio with stearic acid (solid data) over a period of 5 days.

FIG. 5 is a plot of the CO₂ production rate of untreated avocados (broken line) and avocados treated with 10 g/L of 95% w/w glycerol monostearate and 5% w/w lysine in a 1:1 molar ratio with stearic acid (solid line) avocados over a period of 5 days.

FIG. 6 is a plot of mass loss factor of untreated avocados (non-solid data) and avocados treated with 10 g/L of 95% w/w glycerol monostearate and 5% w/w lysine (solid data) over a period of 5 days.

FIG. 7 is a plot of the CO₂ production rate of untreated avocados (broken line) and avocados treated with 10 g/L of 95% w/w glycerol monostearate and 5% w/w lysine (solid line) avocados over a period of 5 days.

### DETAILED DESCRIPTION

### Compositions

Plant matter can include pre-harvest plants (e.g., growing plants) and post-harvest plants (e.g., plant matter after removal from the area of growth) and other agricultural products such as flowers (among others). Non-limiting examples of plant matter include a fruit, a vegetable, a leaf, a stem, bark, a seed, a flower, and a combination thereof. In some embodiments, the plant matter is a flower. In some embodiments, the plant matter is fresh produce. In some embodiments, the plant matter is a vegetable. In some embodiments, the plant matter is a fruit. Plant matter can have differing availability as an agricultural product due to variabilities in growing season, variabilities in growing location, and rates of ripening, which can affect the shelf life of the agricultural product. The shelf life of such agricultural products can be limited as the desirability of the agricultural product can decrease with age of the product. For example, plant matter can desiccate and have a withered, dry appearance and texture as the plant matter loses mass (e.g., water). Plant matter (e.g., produce, flowers, etc.) can also become ripe (e.g., mature) quickly, which can make the purchase of the plant matter undesirable as the produce may spoil before it has reached its destination and/or been consumed. Further, the ripening and desiccation of the agricultural product may make transport difficult as the agricultural product may grow a distance away from the point of consumption, thus requiring time for transport. The application of a barrier film composition as provided herein to the surface of plant matter can, in some examples, reduce a rate of CO₂ production (e.g., respiration) and/or reduce the rate of mass loss from the plant matter. An edible barrier film composition coating agricultural products can increase shelf life of the plant matter by decreasing mass loss and CO₂ production.

Barrier film compositions as provided herein can be applied to plant matter to minimize moisture loss and respiration, which can extend shelf life of fresh produce. Described herein are barrier film compositions comprised of ion pair amphilphiles, small molecules, and amino acids. As described herein, the ion pair amphiphile and/or an amino acids, hydrogen bonding small molecules, etc. can be effective as an emulsifier for a nonionic amphiphile (e.g., a monoglyceride). In some embodiments, one or more components of the barrier films are natural or derived from naturally occurring materials. The natural aspect of these barrier film compositions can be advantageous when the barrier film composition is coated over edible plant material.

In one aspect, described herein, is a barrier film composition comprising an ion pair (e.g., a first component comprising a charged long chain alkyl and a second component comprising an opposingly charged molecule). In another aspect, described herein is a barrier film composition comprising a nonionic amphiphile and an ion pair (e.g., a first component comprising a charged long chain alkyl and a second component comprising an opposingly charged molecule). In yet another embodiment, described herein, is a barrier film composition comprising a nonionic amphiphile and an amino acids, hydrogen bonding small molecules, etc.

In some embodiments, the barrier film composition comprises an ion pair. In some embodiments, the barrier film composition comprises a first component comprising a charged long chain alkyl molecule and a second component comprising an opposingly charged molecule.

In some embodiments, the long chain alkyl is a hydrocarbon chain having from 12 carbons to 20 carbons. In some embodiments, the charged long chain alkyl is a charged C12 alkyl, a charged C14 alkyl, a charged C16 alkyl, a charged C18 alkyl, a charged C20 alkyl, a charged C22 alkyl, a charged C24 alkyl, a charged C26 alkyl, a charged C28 alkyl, a charged C30 alkyl or a combination thereof.

In some embodiments, the long chain alkyl is positively charged. In some embodiments, the long chain alkyl is an alkyl ammonium (e.g., a long chain quaternary amine). In some embodiments, the long chain alkyl ammonium is a C12 alkyl ammonium to a C30 alkyl ammonium. In some embodiments, the long chain alkyl ammonium is a C12 alkyl ammonium, a C14 alkyl ammonium, a C16 alkyl ammonium, a C18 alkyl ammonium, a C20 alkyl ammonium, a C22 alkyl ammonium, a C24 alkyl ammonium, a C26 alkyl ammonium, a C28 alkyl ammonium, a C30 alkyl ammonium or combinations thereof. In some embodiments, the long chain alkyl ammonium is a C16 long chain alkyl ammonium. In some embodiments, the long chain alkyl ammonium is a C18 long chain alkyl ammonium. In some embodiments, the long chain alkyl ammonium is a C12 alkyl ammonium to a C30 alkyl ammonium. In some embodiments, the long chain alkyl ammonium is a C16 or a C18 alkyl ammonium. Non-limiting examples include:

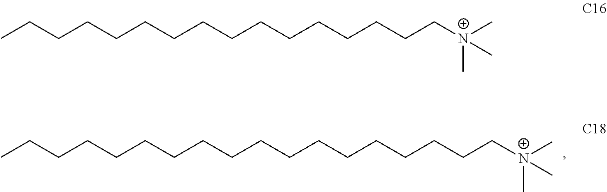

and their respective salts thereof.

In some embodiments, the charged long chain alkyl is a long chain sulfate. In some embodiments, the long chain sulfate has a carbon length of about 12 carbons to about 30 carbons. In some embodiments, the long chain sulfate is a C12 sulfate, a C14 sulfate, a C16 sulfate, a C18 sulfate, a C20 sulfate, a C22 sulfate, a C24 sulfate, a C26 sulfate, a C28 sulfate, a C30 sulfate, or a combination thereof. A non-limiting example of a long chain sulfate is hexadecyl sulfate, octadecyl sulfate, hexadecysulfonic acid, or octadecylsulfonic acid, or a salt thereof.

In some embodiments the long chain alkyl is a long chain sulfonate. In some embodiments, the long chain sulfonate has a carbon length of about 12 carbons to about 30 carbons. In some embodiments, the long chain sulfonate is a C12 sulfonate, a C14 sulfonate, a C16 sulfonate, a C18 sulfonate, a C20 sulfonate, a C22 sulfonate, a C24 sulfonate, a C26 sulfonate, a C28 sulfonate, a C30 sulfonate, or a combination thereof.

In some embodiments, the long chain alkyl is negatively charged. In some embodiments the long chain alkyl is a dianion. In some embodiments, the charged long chain alkyl is a long chain phosphate. In some embodiments, the long chain phosphate has a carbon length of about 12 carbons to about 30 carbons. In some embodiments, the long chain phosphate is a C12 phosphate, a C14 phosphate, a C16 phosphate, a C18 phosphate, a C20 phosphate, a C22 phosphate, a C24 phosphate, a C26 phosphate, a C28 phosphate, a C30 phosphate, or a combination thereof In some embodiments, the long chain phosphate is cetyl phosphate or a salt thereof. A non-limiting example of a long chain phosphate is cetyl phosphate or stearoyl phosphate, or a salt thereof. A non-limiting example of a long chain phosphate is cetyl phosphate or stearoyl phosphate, or a salt thereof. In some embodiments, the long chain alkyl is derived from a fatty acid alcohol. A non-limiting example of a fatty acid alcohol is palmitic cetyl alcohol or stearyl alcohol stearic acid.

In some embodiments, the long chain alkyl is negatively charged. In some embodiments, the long chain alkyl is a monoanion. In some embodiments, the charged long chain alkyl is a long chain hydrogen phosphate (i.e., biphosphate). In some embodiments, the long chain hydrogen phosphate has a carbon length of about 12 carbons to about 30 carbons. In some embodiments, the long chain hydrogen phosphate is a C12 hydrogen phosphate, a C14 hydrogen phosphate, a C16 hydrogen phosphate, a C18 hydrogen phosphate, a C20 hydrogen phosphate, a C22 hydrogen phosphate, a C24 hydrogen phosphate, a C26 hydrogen phosphate, a C28 hydrogen phosphate, a C30 hydrogen phosphate, or a combination thereof. In some embodiments, the long chain hydrogen phosphate is cetyl hydrogen phosphate or a salt thereof. A non-limiting example of a long chain hydrogen phosphate is cetyl hydrogen phosphate or stearoyl hydrogen phosphate, or a salt thereof. In some embodiments, the long chain alkyl is derived from a fatty alcohol. A non-limiting example of a fatty alcohol is cetyl alcohol or stearyl alcohol.

In some embodiments, the long chain alkyl is negatively charged. In some embodiments the long chain alkyl is a monoanion. In some embodiments, the long chain alkyl is a monoalkyl phosphate. In some embodiments, the alkyl group of the monoalkyl phosphate has a carbon length of about 12 carbons to about 30 carbons. In some embodiments, the alkyl groups of the monoalkyl phosphate has a carbon length of 12 carbons, of 14 carbons, of 16 carbons, of 18 carbons, of 20 carbons, of 22 carbons, of 24 carbons, of 26 carbons, of 28 carbons, of 30 carbons, or a combination thereof.

In some embodiments, the long chain alkyl is a dialkyl phosphate. In some embodiments, the carbon lengths of the two alkyl groups are the same. In some embodiments, the carbon lengths of the two alkyl groups are different. In some embodiments, one or more of the alkyl groups of the dialkyl phosphate has a carbon length of about 12 carbons to about 30 carbons. In some embodiments, one or more of the alkyl groups of the dialkyl phosphate has a carbon length of 12 carbons, of 14 carbons, of 16 carbons, of 18 carbons, of 20 carbons, of 22 carbons, of 24 carbons, of 26 carbons, of 28 carbons, of 30 carbons, or a combination thereof.

In some embodiments, one of the alkyl groups of the dialkyl phosphate has a carbon length of less than 12 carbons, less than 10 carbons, less than 8 carbons, less than 6 carbons, less than 4 carbons, or less than 2 carbons. In some embodiments, one of the alkyl groups of the dialkyl phosphate has a carbon length of 11 carbons, of 10 carbons, of 8 carbons, of 6 carbons, of 4 carbons, of 3 carbons, of 2 carbons, or of 1 carbon.

In some embodiments, the long chain alkyl is negatively charged. In some embodiments, the long chain alkyl is a dianion. In some embodiments, the charged long chain alkyl is a long chain phosphonate. In some embodiments, the long chain phosphonate has a carbon length of about 12 carbons to about 30 carbons. In some embodiments, the long chain phosphonate is a C12 phosphonate, a C14 phosphonate, a C16 phosphonate, a C18 phosphonate, a C20 phosphonate, a C22 phosphonate, a C24 phosphonate, a C26 phosphonate, a C28 phosphonate, a C30 phosphonate, or a combination thereof. In some embodiments, the long chain phosphonate is hexadecyl phosphonate or a salt thereof. A non-limiting example of a long chain phosphonate is hexadecyl phosphonate or octadecyl phosphonate, or a salt thereof.

In some embodiments, the long chain alkyl is negatively charged. In some embodiments, the long chain alkyl is a monoanion. In some embodiments, the charged long chain alkyl is a long chain hydrogen phosphonate. In some embodiments, the long chain hydrogen phosphonate has a carbon length of about 12 carbons to about 30 carbons. In some embodiments, the long chain hydrogen phosphonate is a C12 hydrogen phosphonate, a C14 hydrogen phosphonate, a C16 hydrogen phosphonate, a C18 hydrogen phosphonate, a C20 hydrogen phosphonate, C22 hydrogen phosphonate, C24 hydrogen phosphonate, C26 hydrogen phosphonate, C28 hydrogen phosphonate, C30 hydrogen phosphonate, or a combination thereof. In some embodiments, the long chain hydrogen phosphonate is hexadecyl phosphonate or a salt thereof. A non-limiting example of a long chain hydrogen phosphonate is hexadecyl hydrogen phosphonate or octadecyl hydrogen phosphonate, or a salt thereof.

In some embodiments, the long chain alkyl is negatively charged. In some embodiments, the long chain alkyl is a monoanion. In some embodiments, the charged long chain alkyl is a long chain alkyl phosphonate. In some embodiments, the alkyl group on the oxygen of the alkyl phosphonate is about 2 carbons, is about 4 carbons, is about 6 carbons, is about 8 carbons, is about 10 carbons, is about 12 carbons, is about 14 carbons, is about 16 carbons, or is about 20 carbons. In some embodiments, the alkyl group on the oxygen side of the alkyl phosphonate has a carbon length of less than 20 carbons, less than 18 carbons, less than 16 carbons, less than 14 carbons, less than 12 carbons, less than 10 carbons, less than 8 carbons, less than 6 carbons, less than 4 carbons, or less than 2 carbons.

In some embodiments, the alkyl group on the oxygen of the alkyl phosphonate has a carbon length of 20 carbons, of 18 carbons, of 16 carbons, of 14 carbons, of 12 carbons, of 11 carbons, of 10 carbons, of 8 carbons, of 6 carbons, of 4 carbons, of 3 carbons, of 2 carbons, or of 1 carbon. In some embodiments, the long chain phosphonate has a carbon length on the phosphorous side of the alkyl phosphonate of about 12 carbons to about 30 carbons. In some embodiments, the long chain phosphonate has a carbon length on the phosphorous side of the alkyl phosphonate of 12 carbons, of 14 carbons, of 16 carbons, of 18 carbons, of 20 carbons, of 22 carbons, of 24 carbons, of 26 carbons, of 28 carbons, of 30 carbons, or a combination thereof.

In some embodiments, the long chain alkyl is negatively charged. In some embodiments, the long chain alkyl is a monoanion. In some embodiments, the charged long chain alkyl is a fatty acid. In some embodiments, the fatty acid has a carbon length of about 12 carbons to about 30 carbons. In some embodiments, the fatty acid is a C10 fatty acid, a C12 fatty acid, a C14 fatty acid, a C16 fatty acid, a C18 fatty acid, a C20 fatty acid, a C22 fatty acid, a C24 fatty acid, a C26 fatty acid, a C28 fatty acid, a C30 fatty acid, or a combination thereof.

In some embodiments, the fatty acid is a monounsaturated fatty acid or salt or ester thereof, a polyunsaturated fatty acid or salt or ester thereof, a saturated fatty acid or salt or ester thereof, or a combination thereof. In some embodiments, the fatty acid is a saturated fatty acid.

In some embodiments, the fatty acid or salts or esters thereof include lauric acid, myristic acid, palmitic acid, stearic acid, arachidic acid, oleic acid, or combinations thereof. In some embodiments, the fatty acid is stearic acid.

In some embodiments, the second component of the ion pair is a counter ion to the first component (i.e., the second component is oppositely charged as compared to the first component). In some embodiments, the second component is an ammonium compound. In some embodiments, the second component is a protonated ammonium. In some embodiments, the second component is a trimethyl ammonium. In some embodiments, the second component is a salt or a zwitterion. In some embodiments, the second component is an amino acid. In some embodiments, the second component comprises one or more of or is selected from the group consisting of L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, and a combination thereof.

Non-limiting examples of the second component include salts of the following:

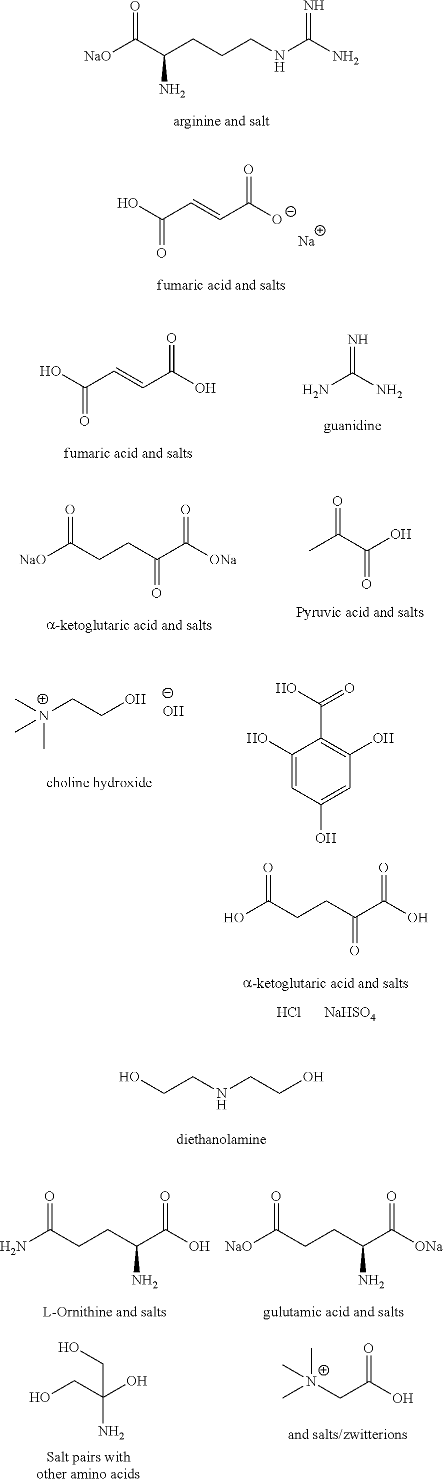

In some embodiments, the second component is an amino acid. In some embodiments, the second component is an amino acid salt. In some embodiments, the amino acid becomes charged, or a percentage becomes charged, due to a reaction with the solvent. In some embodiments, the charged amino acid comprises one or more of or is selected from the group consisting of L-arginine, L-histidine, L-lysine, or a combination thereof. In some embodiments, the charged amino acid is L-arginine. In some embodiments, the charged amino acid is L-histidine. In some embodiments, the charged amino acid is L-lysine.

In some embodiments, the second component is a charged amino acid. In some embodiments, the charged amino acid is positively charged due to protonation or alkylation. In some embodiments, the charged amino acid comprises one or more of or is selected from the group consisting of L-arginine hydrochloride, L-histidine hydrochloride, L-lysine hydrochloride, or a combination thereof. In some embodiments, the charged amino acid is L-arginine sulfate. In some embodiments, the charged amino acid is L-histidine sulfate. In some embodiments, the charged amino acid is L-lysine sulfate.

In some embodiments, the ion pair is formed through a salt metathesis between the long alkyl chain component and partner molecule. In some embodiments, the ion pair is formed by a proton transfer between the two components, giving rise to the ion pair. To form the ion pair by proton transfer, one component must serve as a proton donor and another as a proton acceptor. In some embodiments, the ion pair is formed by the amino acid being protonated by a fatty acid, giving a positively charged amino acid and negatively charged fatty acid.

In some embodiments, a barrier film described herein can comprise a nonionic amphiphile. In some embodiments, an ion pair (e.g., a charged long chain alkyl and a second component having an opposing charge) can be used in combination with the nonionic amphiphile.

In some embodiments, a barrier film composition comprises an ion pair (e.g., a charged long chain alkyl and a second component having an opposing charge) and a nonionic amphiphile.

In some embodiments, the nonionic amphiphile has a carbon length that comprises one or more of or is selected from the group consisting of a nonionic C10 amphiphile, a nonionic C12 amphiphile, a nonionic C14 amphiphile, a nonionic C16 amphiphile, a nonionic C18 amphiphile, a nonionic C20 amphiphile, a nonionic C22 amphiphile, a nonionic C24 amphiphile, a nonionic C26 amphiphile, a nonionic C28 amphiphile, a nonionic C30 amphiphile, a nonionic C32 amphiphile, a nonionic C34 amphiphile, a nonionic C36 amphiphile, a nonionic C38 amphiphile, a nonionic C40 amphiphile, a nonionic C42 amphiphile, a nonionic C44 amphiphile, a nonionic C46 amphiphile, a nonionic C48 amphiphile, a nonionic C50 amphiphile, or a combination thereof.

In some embodiments, the ion pair (e.g., a charged long chain alkyl and a second component having an opposing charge) and the nonionic amphiphile are combined together. In some embodiments, a mixture of the nonionic amphiphile and the ion pair (e.g., a charged long chain alkyl and a second component having an opposing charge) are homogenized with water.

In some embodiments, the charged long chain alkyl is about 0 g/L to about 300 g/L. In some embodiments, the long chain alkyl is about 10 g/L to about 300 g/L, about 20 g/L to about 300 g/L, about 30 g/L to about 300 g/L, about 40 g/L to about 300 g/L, about 50 g/L to about 300 g/L, about 60 g/L to about 300 g/L, about 70 g/L to about 300 g/L, about 80 g/L to about 300 g/L, about 90 g/L to about 300 g/L, about 100 g/L to about 300 g/L, about 110 g/L to about 300 g/L, about 120 g/L to about 300 g/L, about 130 g/L to about 300 g/L, about 140 g/L to about 300 g/L, about 150 g/L to about 300 g/L, about 160 g/L to about 300 g/L, about 170 g/L to about 300 g/L, about 180 g/L to about 300 g/L, about 190 g/L to about 300 g/L, about 200 g/L to about 300 g/L, about 210 g/L to about 300 g/L, about 220 g/L to about 300 g/L, about 230 g/L to about 300 g/L, about 240 g/L to about 300 g/L, about 250 g/L to about 300 g/L, about 260 g/L to about 300 g/L, about 270 g/L to about 300 g/L, or about 280 g/L to about 300 g/L.

In some embodiments, a second component having an opposing charge is 0 g/L to about 300 g/L. In some embodiments, the second component having an opposing charge is about 10 g/L to about 300 g/L, about 20 g/L to about 300 g/L, about 30 g/L to about 300 g/L, about 40 g/L to about 300 g/L, about 50 g/L to about 300 g/L, about 60 g/L to about 300 g/L, about 70 g/L to about 300 g/L, about 80 g/L to about 300 g/L, about 90 g/L to about 300 g/L, about 100 g/L to about 300 g/L, about 110 g/L to about 300 g/L, about 120 g/L to about 300 g/L, about 130 g/L to about 300 g/L, about 140 g/L to about 300 g/L, about 150 g/L to about 300 g/L, about 160 g/L to about 300 g/L, about 170 g/L to about 300 g/L, about 180 g/L to about 300 g/L, about 190 g/L to about 300 g/L, about 200 g/L to about 300 g/L, about 210 g/L to about 300 g/L, about 220 g/L to about 300 g/L, about 230 g/L to about 300 g/L, about 240 g/L to about 300 g/L, about 250 g/L to about 300 g/L, about 260 g/L to about 300 g/L, about 270 g/L to about 300 g/L, or about 280 g/L to about 300 g/L.

In some embodiments, the barrier film composition comprises a combination of about 1% w/w to about 99% w/w of the nonionic amphiphile and the ion pair (e.g., a charged long chain alkyl and a second component having an opposing charge). In some embodiments, the nonionic amphiphile comprises about 1% w/w to about 99% w/w of the nonionic amphiphile. In some embodiments, the nonionic amphiphile is about 10% w/w to about 99% w/w, 20% w/w to about 99% w/w, 30% w/w to about 99% w/w, 40% w/w to about 99% w/w, 50% w/w to about 99% w/w, 60% w/w to about 99% w/w, 70% w/w to about 99% w/w, 80% w/w to about 99% w/w, or 90% w/w to about 99% w/w.

In some embodiments, the barrier film composition comprises about 94% w/w to about 98% w/w of the nonionic amphiphile. In some embodiments, the barrier film composition comprises about 95% w/w of the nonionic amphiphile. In some embodiments, the ion pair (e.g., a charged long chain alkyl and a second component having an opposing charge) is 1% w/w to about 99% w/w of the ion par. In some embodiments, the ion pair is about 10% w/w to about 99% w/w, 20% w/w to about 99% w/w, 30% w/w to about 99% w/w, 40% w/w to about 99% w/w, 50% w/w to about 99% w/w, 60% w/w to about 99% w/w, 70% w/w to about 99% w/w, 80% w/w to about 99% w/w, or 90% w/w to about 99% w/w.

In some embodiments, the nonionic amphiphile comprises one or more of or is selected from the group consisting of polyoxyethylene (2) stearyl ether (Brij-72), polyoxyethylene (10) stearyl ether (Brij-76), polyoxyethylene (20) stearyl ether (Brij-78), polyoxyethylene (2) oleyl ether (Brij-92), polyoxyethylene (10) oleyl ether (Brij-97), polyoxyethylene (20) oleyl ether (Brij-98), monobehenin, monoarachidin, monostearin, monopalmitin, monolaurin, sucrose esters, sucroglycerides, diglycerolmonostearate, triglycerolmonostearate, sorbitan monostearates, fatty alcohols, carnauba wax, candelilla wax, DATEM, beeswax, shellac wax, or a combination thereof.

In some embodiments, the nonionic amphiphile is an ethyl ester of a fatty acid. In some embodiments, the nonionic amphiphile is an ester of a fatty acid. In some embodiments, the nonionic amphiphile is an ethyl ester of a C10 fatty acid to a C30 fatty acid. In some embodiments, the nonionic amphiphile is an ester of a C10 fatty acid to a C30 fatty acid.

In some embodiments, the nonionic amphiphile comprises a functional group that can partially ionize in solution. Non-limiting examples of such nonionic amphilphiles are cholesterol, glycolipids, bile acids, saponins, long-chain alcohols, lipopeptides, lipoproteins, and combinations thereof.

In some embodiments, the nonionic amphiphile is a diglyceride. In some embodiments, the nonionic amphiphile is a diacylglycerol. In some embodiments, the nonionic amphiphile is a 1,2-diacylglycerol. In some embodiments, the nonionic amphiphile is a 1,3-diacylglycerols.

In some embodiments, one or more fatty acids, fatty acid esters, or a combination thereof comprise one monoglyceride (e.g., a 1-monoglyceride or a 2-monoglyceride). In some embodiments, the one or more fatty acids, fatty acid esters, or a combination thereof comprise two monoglycerides (e.g., two 1-monoglycerides, two 2-monoglycerides, or one 1-monoglyceride and one 2-monoglyceride).

In some embodiments, the compositions (e.g., the coating agents or coatings) comprise one or more fatty acid derivatives. In some embodiments, the one or more fatty acid derivatives comprise one or more fatty acids, fatty acid esters, or a combination thereof. In some embodiments, the one or more fatty acid derivatives comprise one or more fatty acid salts. In some embodiments, the one or more fatty acid derivatives comprise two or more fatty acids, fatty acid esters, or a combination thereof. In some embodiments, the one or more fatty acid derivatives comprise two or more fatty acid salts. In some embodiments, the one or more fatty acid derivatives comprise one or more fatty acids, fatty acid esters, or a combination thereof and one or more fatty acid salts. In some embodiments, the one or more fatty acid derivatives comprise two or more fatty acids, fatty acid esters, or a combination thereof and two or more fatty acid salts. In some embodiments, the one or more fatty acid derivatives comprise one fatty acid or ester thereof and one fatty acid salt. In some embodiments, the one or more fatty acid derivatives comprise one fatty acid thereof and one fatty acid salt. In some embodiments, the one or more fatty acid derivatives comprise one fatty acid ester and one fatty acid salt. In some embodiments, the one or more fatty acid derivatives comprise two fatty acids, fatty acid esters, or a combination thereof and two fatty acid salts. In some embodiments, the one or more fatty acid derivatives comprise two fatty acid esters and two fatty acid salts. In some embodiments, the one or more fatty acid derivatives comprise two fatty acid esters and one fatty acid salt. In some embodiments, the one or more fatty acid derivatives comprise one fatty acid ester, one fatty acid, and one fatty acid salts. In some embodiments, the one or more fatty acid derivatives comprise one fatty acid ester and one fatty acid salt.

In some embodiments, the one or more fatty acids, fatty acid esters, or a combination thereof comprise one or more fatty acid esters. In some embodiments, the one or more fatty acid esters is one fatty acid ester. In some embodiments, the one or more fatty acid esters is two fatty acid esters.

In some embodiments, the one or more fatty acid salts is one fatty acid salt. In some embodiments, the one or more fatty acid salts is two fatty acid salts.

In some embodiments, the one or more fatty acids, fatty acid esters, or a combination thereof comprise one monoglyceride (e.g., a 1-monoglyceride or a 2-monoglyceride). In some embodiments, the one or more fatty acids, fatty acid esters, or a combination thereof comprise two monoglycerides (e.g., two 1-monoglycerides, two 2-monoglycerides, or one 1-monoglyceride and one 2-monoglyceride).

In some embodiments, the nonionic amphiphile is a glyceride. In some embodiments, the nonionic amphiphile is a saturated glyceride. In some embodiments, the saturated glyceride is a saturated monoglyceride, saturated diglyceride, or a combination thereof. In some embodiments, the saturated glyceride is a saturated monoglyceride.

In some embodiments, the saturated monoglyceride has about 10 carbons to about 20 carbons, about 12 carbons to about 20 carbons, about 14 carbons to about 20 carbons, about 16 carbons to about 20 carbons, about 18 carbons to about 20 carbons, about 10 carbons to about 18 carbons, about 10 carbons to about 16 carbons, about 10 carbons to about 14 carbons, or about 10 carbons to about 12 carbons. In some embodiments, the saturated monoglyceride has about 14 carbons and about 18 carbons, about 14 carbons to about 16 carbons, or about 16 carbons to about 18 carbons.

In some embodiments, the saturated monoglyceride is a C10 monoglyceride, a C12 monoglyceride, a C14 monoglyceride, a C16 monoglyceride, a C18 monoglyceride, or a C20 monoglyceride. In some embodiments, saturated monoglyceride is monolaurin, glyceryl monostearate, glyceryl hydroxystearate, and a combination thereof. In some embodiments, the glyceryl hydroxystearate comprises or is selected from the group consisting of 12-hydroxystearate, glycerol monohydroxystearate, glycerol (2-(12-hydroxystearate)), glyceryl triacetyl 12-hydroxystearate, cholesteryl hydroxystearate, isopropyl hydroxystearate, heptylundecyl hydroxystearate, potassium hydroxystearate, lithium methyl 12-hydroxystearate, calcium 7-hydroxystearate, (S)-2-hydroxystearate, 18-hydroxystearate, 2-hydroxystearate, 3-hydroxystearate, benzyl 2-hydroxystearate, calcium 12-hydroxystearate, magnesium hydroxystearate, trimethylolpropane bis(18-hydroxystearate), and a combination thereof.

In some embodiments, the molar ratio of the ion pair (e.g., the charged long chain alkyl to the second component having an opposing charge) is about 1:3 to about 3:1.

In some embodiments, the first component is a charged long chain alkyl. For example, the molar ratio of the barrier film composition may be a range of about 1:3 to about 3:1 charged long chain alkyl to second component having an opposing charge.

In some embodiments, the first component is a charged long chain alkyl and the second component is an amino acid having an opposing charge. In some embodiments, the molar ratio of the ion pair (e.g., the charged long chain alkyl to the charged amino acid) is about 1:3 to about 3:1.

In some embodiments, the first component is cetyl phosphate or a salt thereof and the second component is L-arginine. In some embodiments, the molar ratio of the ion pair (e.g., the cetyl phosphate or a salt thereof to the L-arginine) is about 1:3 to about 3:1.

In some embodiments, the first component is cetyl phosphate or a salt thereof and the second component is L-lysine. In some embodiments, the molar ratio of the ion pair (e.g., the cetyl phosphate or a salt thereof to the L-lysine) is about 1:3 to about 3:1.

In some embodiments, the first component is cetyl phosphate or a salt thereof and the second component is L-histidine. In some embodiments, the molar ratio of the ion pair (e.g., the cetyl phosphate or a salt thereof to the L-histidine) is about 1:3 to about 3:1.

In some embodiments, the first component is stearic acid or a salt thereof and the second component is L-arginine. In some embodiments, the molar ratio of the ion pair (e.g., the stearic acid or a salt thereof to the L-arginine) is about 1:3 to about 3:1.

In some embodiments, the first component is stearic acid or a salt thereof and the second component is L-lysine. In some embodiments, the molar ratio of the ion pair (e.g., the stearic acid or a salt thereof to the L-lysine) is about 1:3 to about 3:1.

In some embodiments, the first component is stearic acid or a salt thereof and the second component is L-histidine. In some embodiments, the molar ratio of the ion pair (e.g., the stearic acid or a salt thereof to the L-histidine) is about 1:3 to about 3:1.

In some embodiments, the barrier film composition comprises a first component of a long chain phosphate and a second component of a long organic counter ion (e.g., an amino acid). In some embodiments, the barrier film composition comprises a first component of a long chain phosphate and a second component of a basic amine. In some embodiments, a barrier film composition comprises a first component of a long chain phosphate and a second component of a charged amino acid. In some embodiments, the charged long chain alkyl is a charged long chain phosphate. In some embodiments, the molar ratio of the ion pair (e.g., the charged long chain phosphate to the second component having an opposing charge) is about 1:3 to about 3:1.

In some embodiments, the barrier film composition comprises a first component of a long chain hydrogen phosphate and a second component of a long organic counter ion (e.g., an amino acid). In some embodiments, a barrier film composition comprises a first component of a long chain hydrogen phosphate and a second component of a charged amino acid. In some embodiments, the charged long chain alkyl is a charged long chain hydrogen phosphate. In some embodiments, the molar ratio of the ion pair (e.g., the charged long chain hydrogen phosphate to the second component having an opposing charge) is about 1:3 to about 3:1.

In some embodiments, the barrier film composition comprises a first component of a monoalkyl phosphate and a second component of a long organic counter ion (e.g., an amino acid). In some embodiments, a barrier film composition comprises a first component of a monoalkyl phosphate and a second component of a charged amino acid. In some embodiments, the charged long chain alkyl is a charged monoalkyl phosphate. In some embodiments, the molar ratio of the ion pair (e.g., the charged monoalkyl phosphate to the second component having an opposing charge) is about 1:3 to about 3:1.

In some embodiments, the barrier film composition comprises a first component of a dialkyl phosphate and a second component of a long organic counter ion (e.g., an amino acid). In some embodiments, a barrier film composition comprises a first component of a dialkyl phosphate and a second component of a charged amino acid. In some embodiments, the charged long chain alkyl is a charged dialkyl phosphate. In some embodiments, the molar ratio of the ion pair (e.g., the charged dialkyl phosphate to the second component having an opposing charge) is about 1:3 to about 3:1.

In some embodiments, the barrier film composition comprises a first component of a long chain alkyl phosphonate and a second component of a long organic counter ion (e.g., an amino acid). In some embodiments, a barrier film composition comprises a first component of a long chain alkyl phosphonate and a second component of a charged amino acid. In some embodiments, the charged long chain alkyl is a charged long chain alkyl phosphonate. In some embodiments, the molar ratio of the ion pair (e.g., the charged long chain alkyl phosphonate to the second component having an opposing charge) is about 1:3 to about 3:1.

In some embodiments, the barrier film composition comprises a first component of a long chain hydrogen phosphonate and a second component of a long organic counter ion (e.g., an amino acid). In some embodiments, a barrier film composition comprises a first component of a long chain hydrogen phosphonate and a second component of a charged amino acid. In some embodiments, the charged long chain alkyl is a charged long chain hydrogen phosphonate. In some embodiments, the molar ratio of the ion pair (e.g., the charged long chain hydrogen phosphonate to the second component having an opposing charge) is about 1:3 to about 3:1.

In some embodiments, the charged long chain alkyl is a fatty acid. In some embodiments, the molar ratio of the ion pair (e.g., the fatty acid to the second component having an opposing charge) is about 1:3 to about 3:1. In some embodiments, the barrier film composition comprises first component of a fatty acid and a second component having an opposing charge (e.g., a charged amino acid). In some embodiments, the barrier film composition comprises first component of a fatty acid salt and a second component having an opposing charge (e.g., a charged amino acid). In some embodiments, a barrier film composition comprises a first component of a fatty acid and a second component of a charged amino acid. In some embodiments, a barrier film composition comprises a first component of a fatty acid salt and a second component of a charged amino acid.

In some embodiments, the first component is a charged long chain phosphate and the second component is an amino acid having an opposing charge. In some embodiments, the first component is a charged long chain phosphate salt and the second component is an amino acid having an opposing charge. In some embodiments, the molar ratio of the ion pair (e.g., the charged long chain phosphate or salt to the charged amino acid) is about 1:3 to about 3:1.

In some embodiments, the first component is a fatty acid or salt and the second component is an amino acid having an opposing charge. In some embodiments, the molar ratio of the ion pair (e.g., the fatty acid to the charged amino acid) is about 1:3 to about 3:1.

In some embodiments, the barrier film composition comprises a first component of a long chain sulfate and a second component of a long organic counter ion (e.g., an amino acid). In some embodiments, a barrier film composition comprises a first component of a long chain sulfate and a second component of a charged amino acid. In some embodiments, the charged long chain alkyl is a charged long chain sulfate. In some embodiments, the molar ratio of the ion pair (e.g., the charged long chain sulfate to the second component having an opposing charge) is about 1:3 to about 3:1.

In some embodiments, the barrier film composition comprises a first component of a long chain sulfonate and a second component of a long organic counter ion (e.g., an amino acid). In some embodiments, a barrier film composition comprises a first component of a long chain sulfonate and a second component of a charged amino acid. In some embodiments, the charged long chain alkyl is a charged long chain sulfonate. In some embodiments, the molar ratio of the ion pair (e.g., the charged long chain sulfonate to the second component having an opposing charge) is about 1:3 to about 3:1.

In some embodiments, the barrier film composition comprises a first component of a long chain alkyl ammonium and a second component of a long organic counter ion (e.g., an amino acid). In some embodiments, a barrier film composition comprises a first component of a long chain alkyl ammonium and a second component of a charged amino acid. In some embodiments, the charged long chain alkyl is a charged long chain alkyl ammonium. In some embodiments, the molar ratio of the ion pair (e.g., the charged long chain alkyl ammonium to the second component having an opposing charge) is about 1:3 to about 3:1.

In some embodiments, a barrier film composition comprises a first component comprising a nonionic amphiphile and a second charged component. In some embodiments, the second component is zwitterionic. In some embodiments, the nonionic amphiphile has a carbon length comprises one or more of or is selected from the group consisting of a C10 nonionic amphiphile, a C12 nonionic amphiphile, a C14 nonionic amphiphile, a C16 nonionic amphiphile, a C18 nonionic amphiphile, a C20 nonionic amphiphile, or a combination thereof. In some embodiments, the nonionic amphiphile is a monoglyceride. In some embodiments, the nonionic amphiphile is a saturated monoglyceride. In some embodiments, the nonionic amphiphile is a sucrose ester. In some embodiments, the nonionic amphiphile is a sucroglycerides.

In some embodiments, the second component comprises or is selected from the group consisting of L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, and a combination thereof.

In some embodiments, the second component is an amino acid. In some embodiments, the second component comprises or is selected from the group consisting of L-arginine, L-lysine, L-histidine, and a combination thereof. In some embodiments, the second component is L-arginine. In some embodiments, the second component is L-lysine. In some embodiments, the second component is L-histidine.

In some embodiments, the second component is about 1% w/v to about 99% w/v of the barrier film composition. In some embodiments, the second component is about 10% w/v to about 99% w/v, about 20% w/v to about 99% w/v, about 30% w/v to about 99% w/v, about 40% w/v to about 99% w/v, about 50% w/v to about 99% w/v, about 60% w/v to about 99% w/v, about 70% w/v to about 99% w/v, about 80% w/v to about 99% w/v, or about 90% w/v to about 99% w/v.

In some embodiments, the amino acid is about 1% w/w to about 10% w/w of the barrier film composition.

In some embodiments, the barrier film composition comprises about 90% w/w to about 99% w/w of the monoglyceride. In some embodiments, the barrier film composition comprises about 92% w/w to about 99% w/w of the monoglyceride, about 94% w/w to about 99% w/w, about 96% w/w to about 99% w/w, about 97% w/w to about 99% w/w. In some embodiments, the barrier film composition comprises about 94% w/w to about 98% w/w.

In some embodiments, any of the barrier film compositions described herein can further comprise one or more additives. In some embodiments, the additive comprises or is selected from the group consisting of water, a stabilizer, viscosity modifier, a buffer, an essential oil, a preservative, a vitamin, a mineral, a pigment, a fragrance, an enzyme, a catalyst, an anti-oxidant, a pH modifier, an antimicrobial, an antifungal, or a combination thereof. In some embodiments, an additive as provided herein can serve multiple functions, and as such, the examples of specific additives belonging to a particular class should not be viewed as limiting. In some embodiments, the additive alters the taste, look, texture, smell, or durability of the composition.

In some embodiments, the stabilizer is alginic acid, agar agar, carrageenan, gelatin, pectin, xanthan gum, carboxymethylcellulose, glucomannan, other polysaccharides, or combinations thereof.

In some embodiments, the viscosity modifier is alginic acid, agar agar, carrageenan, gelatin, pectin, xanthan gum, carboxymethylcellulose, glucomannan, other polysaccharides, or combinations thereof.

In some embodiments, the barrier film composition comprises a pH modifier and/or a buffer in an amount that is sufficiently effective to adjust the pH of the barrier film composition. In some embodiments, a pH modifier is a source of protons or hydroxides, or precursors thereof. In some embodiments, the pH modifier and/or buffer comprises or is selected from the group consisting of a citrate salt, a phosphate salt, a tartrate salt, carbonate, bicarbonate, acetic acid, sodium acetate, ammonia, ammonium chloride, TAPS, bicine, tris, tricine, succinate, histidine, alkanolamines such as monoethanolamine, diethanolamine, triethanolamine, monopropanolamine, dipropanolamine, tripropanolamine, 2-amino-2-methyl-1-propanol, and 2-amino-2-hydroxymethyl-1,3,-propandiol and guanidium salts, alkali metal and ammonium hydroxides and carbonates, preferably sodium hydroxide and ammonium carbonate, and acidulants such as inorganic and organic acids, e.g., phosphoric acid, acetic acid, ascorbic acid, citric acid or tartaric acid, hydrochloric acid, and mixtures thereof.

In some embodiments, the essential oil comprises or is selected from the group consisting of African basil, bishop's weed, cinnamon, clove, coriander, cumin, garlic, kaffir lime, lime, lemongrass, mustard oil, menthol, oregano, rosemary, savory, Spanish oregano, thyme, anise, ginger, bay leaf, sage, bergamot, eucalyptus, melaleuca, peppermint, spearmint, wintergreen, cannabis, marjoram, orange, rose, thyme oil, other plant-derived oils, and a combination thereof. In some embodiments, only select compounds found in essential oils may be added.

In some embodiments, the preservative is a nitrite derivative or salt thereof, a sulfite derivative or salt thereof, a benzoate derivative or salt thereof, or combinations thereof. In some embodiments, the preservative is butylated hydroxyanisole, butylated hydroxytoluene, or combinations thereof.

In some embodiments, the vitamin is selected from the class of A vitamins or derivatives thereof, selected from the class of B vitamins or derivatives thereof, selected from the class of C vitamins or derivatives thereof, selected form the class of D vitamins or derivatives thereof, selected from the class of E vitamins or derivatives thereof, or combinations thereof.

In some embodiments, the mineral is a macromineral, a trace mineral, or combinations thereof. In some embodiments, the mineral is iron, manganese, copper, iodine, zinc, cobalt, fluoride, selenium, or combinations thereof.

In some embodiments, the pigment is blue #1, blue #2, green #3, red #3, red #40, yellow #5, yellow #6, citrus red #2, corresponding aluminum lakes thereof, or combinations thereof. In some embodiments, the pigment is selected from those present in nature, such as chlorophyll, carotenes, melanoidins, anthocyanins, curcuma longa, yellow-orange lutein, zeaxanthin, violaxanthin, antheraxanthin, b-cryptoxanthin, carotene, capsanthin, capsorubin, and cryptoxanthin, and combinations thereof.

In some embodiments, the enzyme is an enzyme preparation such as a decarboxylase, an aminopeptidase, an amylase, an asparaginase, a carboxypeptidase, a catalase, a cellulase, a chitinase, a chymosin, a cyprosin, a ficin, a glucanase, an isomerase, a glutaminase, an invertase, a lactase, a lipase, a lyase, a lysozyme, a mannanase, an oxidase, a pectinase, a peptidase, a peroxidase, a phospholipase, a protease, a trypsin, a urease, or combinations thereof.

In some embodiments, the antioxidant is an antioxidant vitamin, a tocopherol, a gallate or derivative thereof, or combinations thereof. In some embodiments, the antioxidant is 4-hexylresorcinol ascorbic acid or a fatty acid esters thereof, sodium ascorbate, calcium ascorbate, citric acid, erythorbic acid, sodium erythorbate, tertiary-butyl hydroquinone, butylated hydroxyanisole, butylated hydroxytoluene, or combinations thereof.

In some embodiments, the compositions further comprise a pH modifier. In some embodiments, the pH modifier is an acid. In some embodiments, the pH modifier is a base. The pH modifier can include, for example, citric acid, acetic acid, hydrochloric acid, sulfuric acid, phosphoric acid, hydrobromic acid, ascorbic acid, tartaric acid, formic acid, gluconic acid, lactic acid, oxalic acid, boric acid, or a combination thereof. In some embodiments, the pH modifier is citric acid.

In some embodiments, the antimicrobial is food-safe. In some embodiments, the food-safe antimicrobial comprises or is selected from the group consisting of sodium benzoate, potassium sorbate, carvacrol, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone intermediate, violastyrene, obtusaquinone, apiole, piperine, celastrol, eugenol, arthonoic acid, leoidin, antimycin A, antimycin Al, natamycin, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(−), citropten, deoxysappanone B trimethyl ether, deoxysappanone B 7,3′-dimethyl ether, 2′,4′-dihydroxy-4-methoxychalcone, daunorubicin hydrochloride, plumbagin, menadione, thymoquinone, levomenthol, thymol, methyl trimethoxycinnamate, chavicol, cinnamylphenol, benzoate, napthoquinone, phenone, acetophenone, benzophenone, phenylacetophenone, salicylic acid, sodium salicylate, methyl salicylate, or chitosan. In some embodiments, the one or more food-safe antimicrobials is benzoate. In some embodiments, the one or more food-safe antimicrobials is sodium benzoate, potassium benzoate, or a combination thereof. In some embodiments, the one or more food-safe antimicrobials is sodium benzoate. In some embodiments, the one or more food-safe antimicrobials is chalcone. In some embodiments, the antifungal comprises or is selected from the group consisting of imidazole, epicatechin, methyl salicylate (MeSA), and combinations thereof.

### Methods

Also provided herein is method of making a barrier film composition, the method comprising combining a first component comprising a charged long chain alkyl, a second component (e.g., a counter ion, a charged amino acid, etc.) having an opposing charge, and water to form an aqueous dispersion.

In some embodiments, the method further comprises combining a nonionic amphiphile with the first component and the second component (e.g., a charged long chain alkyl and a second component having an opposing charge).

Also provided herein, is a method of making a barrier film composition comprising combining a first component comprising a nonionic amphiphile, a second component having a charge, and water to form an aqueous dispersion.

In some embodiments, combining the first component and the second component of the aqueous dispersion includes blending (e.g., homogenizing) the barrier film composition with the water. In some embodiments, the barrier film compositions described herein are homogenized with water. In some embodiments, the water is treated to remove some fraction of hardness and/or dissolved solids. In some embodiments, the water is deionized water. In some embodiments, the water is heated. In some embodiments, the water is heated to a temperature of about 50° C. to about 100° C. In some embodiments, the water is heated to about 60° C. to about 100° C., 70° C. to about 100° C., or about 90° C. to about 100° C. about. In some embodiments, the water is heated to about 100° C.

In some embodiments, combining the first component and the second component includes blending (e.g., homogenizing) the barrier film composition with the water for a period of time. In some embodiments, any of the barrier film compositions described herein are homogenized using any suitable method of homogenization. Commercially available homogenizing devices can be used to homogenize the barrier film composition. In some embodiments, the barrier film composition is homogenized using a blender. In some embodiments, the method further comprises homogenizing the composition prior to applying the barrier film composition to the plant matter. In some embodiments, the period of time is about 1 minute to about 30 minutes. In some embodiments, the period of time is about 2 minutes to about 30 minutes, about 4 minutes to about 30 minutes, about 6 minutes to about 30 minutes, about 8 minutes to about 30 minutes, about 10 minutes to about 30 minutes, about 12 minutes to about 30 minutes, about 14 minutes to about 30 minutes, about 16 minutes to about 30 minutes, about 18 minutes to about 30 minutes, about 20 minutes to about 30 minutes, about 22 minutes to about 30 minutes, about 24 minutes to about 30 minutes, about 26 minutes to about 30 minutes, or about 28 minutes to about 30 minutes. In some embodiments, the barrier film composition is homogenized for a period of time of about 3 minutes. In some embodiments, the barrier film composition is homogenized in a blender for a period of time of about 3 minutes.

In some embodiments, a homogenizing or mixing system can include a heating assembly to heat water or other liquid, a mixing assembly to mix heated water with one or more coating composition materials, and a controller to control one or more operations of the heating assembly and/or mixing assembly. The heating assembly can be configured to deliver a desired volume of heated water or liquid to the mixing assembly. The mixing assembly configured to impart a predetermined shear force to contents of the mixing assembly to effectively and consistently prepare a mixture.

In some embodiments, a mixing system includes a heating assembly configured to heat liquid, and a mixing assembly including a tank defining a cavity and configured to retain liquid, an inlet in fluidic communication with the cavity and configured to receive liquid from the heating assembly, a mixing impeller assembly configured to mix contents of the cavity, an actuator configured to actuate the mixing impeller assembly to mix contents of the cavity, and an outlet in fluidic communication with the cavity and having a valve configured to selectively prevent and permit egress of contents of the cavity.

Embodiments can include some, all, or none of the following features. The mixing impeller can be located below the pumping impeller. The mixing impeller can be configured to generate relatively higher shear than the pumping impeller during operation. The mixing impeller can have a mixing impeller diameter and the tank can have a tank inner diameter, and the mixing impeller diameter can be between 10% and 90% of the tank inner diameter. The mixing impeller diameter can be between 6 in and 36 in. The mixing impeller can be configured as a high shear disc. The tank inner diameter can be measured at the height of the mixing impeller. The pumping impeller can be configured to provide at least 50 turnovers per minute of contents of the tank at an impeller rotational speed between 300 and 5000 revolutions per minute. The mixing impeller can be configured as a three-blade propeller having a diameter between 6 and 36 inches. The rotor shaft can be configured as split shaft having a first section having an axially threaded male portion having a first thread, and a second section having a female portion having a second thread configured to threadedly mate with the first thread such that the first thread is entirely concealed within the second section. The mixing impeller assembly can include a rotor shaft, a pumping impeller configured to be rotated by the rotor shaft, and a mixing impeller configured to be rotated by the rotor shaft. The actuator can be configured to rotate the mixing impeller between 300 RPM and 5000 RPM. The actuator can be configured to rotate the mixing impeller to generate a mixing impeller tip speed between 6 m/s and 14 m/s. The mixing impeller can be separated from the pumping impeller along the rotor shaft by a predetermined fixed distance. The fixed distance can be between 50% and 98% a height of the tank. The mixing assembly may exclude a heating element. The tank may exclude a heating element configured to heat contents of the tank. The heating assembly can be configured to output water to the tank at a temperature between 50° C. and 100° C. The mixing system can be configured to mix a batch having a volume between 80 L and 1500 L. The mixing system can be configured to mix the batch in less than 25 min. A time to fill the tank with hot water from the heating system can be less than 18 min. The heating system can include a collection of heating modules arranged in parallel and configured to simultaneously output heated liquid to the tank. The mixing assembly can be configured to generate a homogenous emulsion at a concentration of greater than 50 grams/liter in a mixing duration of less than 25 minutes. The mixing system can include a portable platform, wherein the heating assembly is affixed to and arranged upon the portable platform. The heating assembly can include a collection of heating modules configured to heat liquid. The collection of heating modules can be a collection of on-demand water heaters. The mixing system can include a portable platform, wherein the mixing assembly is affixed to and arranged upon the portable platform. The mixing system can include at least one of a temperature sensor configured to measure temperature of contents of the cavity, a turbidity sensor configured to measure turbidity of contents of the cavity, and a pressure sensor configured to measure a level of contents of the cavity. The mixing assembly can also include an access port configured to provide access to the cavity. Additional features of mixing systems are described in U.S. Provisional Application No. 63/152,050 which is incorporated by reference in its entirety.

Also provided herein, is a method of coating plant matter with an aqueous dispersion, the method comprising applying the aqueous dispersion to the surface of plant matter.

In some embodiments, a single application of the aqueous dispersion (e.g., the barrier film composition) is used. In some embodiments, multiple applications of the aqueous dispersion are used (e.g., multiple applications of the aqueous dispersion or multiple coats of different aqueous dispersion). In some embodiments, coatings are dried at air temperature or are heated to dry. In some embodiments, coatings are dried in a heated forced air tunnel.

In some embodiments, the method can further include allowing the aqueous dispersion to at least partially evaporate (e.g., dry) for a period of time of about 30 seconds to about 180 seconds after applying aqueous dispersion to the plant matter. In some embodiments, the period of time is about 40 seconds to about 180 seconds, about 50 seconds to about 180 seconds, about 60 seconds to about 180 seconds, about 70 seconds to about 180 seconds, about 80 seconds to about 180 seconds, about 90 seconds to about 180 seconds, about 100 seconds to about 180 seconds, about 110 seconds to about 120 seconds, about 140 seconds to about 180 seconds, about 150 seconds to about 180 seconds, about 160 seconds to about 180 seconds, or about 170 seconds to about 180 seconds. In some embodiments, the period of time is about 60 seconds to about 120 seconds, about 70 seconds to about 120 seconds, about 80 seconds to about 120 seconds, about 90 seconds to about 120 seconds, about 100 seconds to about 120 seconds, or about 110 seconds. In some embodiments, the method further comprises allowing the composition to at least partially evaporate for a period time of about 90 seconds after applying to the plant matter. In some embodiments, the method further comprises allowing the composition to at least partially evaporate for a period time of about 100 seconds after applying to the plant matter. In some embodiments, the method further comprises allowing the composition to at least partially evaporate for a period time of about 110 seconds after applying to the plant matter.

Any of the barrier film compositions described herein can be disposed on the external surface of plant matter (e.g., agricultural product) using any suitable means. In some embodiments, in some embodiments, the plant matter can be dip coated in a bath of the barrier film composition (e.g., an aqueous solution of hydrogen-bonding organic molecules). In some embodiments, applying the barrier film composition to the plant matter comprises dipping the plant matter in the barrier film composition. The barrier film composition can form a thin layer on the surface of plant matter, which can protect the plant matter from biotic stressors, water loss, and/or oxidation.

In some embodiments, a barrier film composition can be applied to an agricultural product via a sprayer or a pulse jet. In some embodiments, the barrier film composition is applied to plant matter in a controller manner. For Example, a modular controlled droplet applicator (CDA) system including a programmable logic controller (PLC) panel, a CDA pump controller, a pump assembly, and a CDA motor assembly can deposit a barrier film composition. The CDA system operates to dispense a liquid coating solution over products beneath the CDA motor assembly. The CDA system is configured to treat (e.g., coat) products such as apples, citrus, berries, melons, peppers, tomatoes, leafy produce, fruits, vegetables, legumes, nuts, flowers, processed food items, candy, vitamins, nutritional supplements, and the like. In various embodiments, the CDA system treats products selected from the group consisting of an apple, an apricot, an avocado, a banana, a blueberry, a bayberry, a cherry, a clementine mandarin, a cucumber, a custard apple, a fig, a grape, a grapefruit, a guava, a kiwifruit, a lime, a lychee, a mamey sapote, a mango, a melon, a mountain papaya, a nectarine, an orange, a papaya, a peach, a pear, a pepper, a persimmon, a pineapple, a plum, a strawberry, a tomato, a watermelon, or combinations thereof. Alternatively or additionally, the CDA system treats non-agricultural products, including paper products, packaging, etc. Additional features of application systems are described in U.S. Provisional Application No. 63/146,917 which is incorporated by reference in its entirety.

In some embodiments, any of the barrier film compositions described herein can be applied using a conveyor system. In some embodiments, the conveyor system includes a brush bed. The applicators can operate to apply a treatment agent on the items being transported on the bed. In some embodiments, a brushing device located along the conveyor bed and having one or more brushes that include. Alternatively or in addition, the items may be coated with the treatment agent by being submerged in the treatment agent.

In some embodiments, the barrier film composition can be dried on the agricultural product. A drying tunnel and a conveyer system configured to move product through the drying tunnel. The treatment system can further be used with, or include, an infeed system, a bed, one or more barrier film composition applicators, and/or a packing station. The infeed system can include a loading system on which items are loaded manually or automatically. In some implementations, the items can be sorted, for example, by size, color, and/or stage of ripening at the infeed system. Alternatively, the items can be sorted before arriving at the infeed system. The bed is configured to transport items at the treatment apparatus, such as from the infeed system to the packing station through different components of the treatment apparatus. The bed can be of various types, such as a brush bed, rolling translating conveyer, etc. The applicators can operate to apply a treatment agent on the items being transported on the bed. Alternatively or in addition, the items may be coated with the treatment agent by being submerged in the treatment agent. The treatment agent may include a barrier film composition. The drying tunnel can operate to remove moisture and dry the barrier film composition applied on the items. The packing station can facilitate packing the treated items for transport.

The drying tunnel can include various components to facilitate drying the barrier film composition on the items. In some implementations, the components may include heated air blowers that are located over drying brushes and drying tunnels with roller conveyors. For example, the drying tunnel can include a blower that pushes hot air into the system and fans along the length providing additional airflow. In another example, the drying tunnel may uses a pressure buildup with a perforated plate to supply high velocity air across the product path. In some embodiments, temperature set points for the drying tunnels are between 45-95° C., 50-90° C., 55-85° C., or 65-80° C. The drying systems may use direct fire burners. Anodized aluminum rollers may be used. The drying tunnels may include air recirculation, and optionally humidity control systems with the addition of a ventilation duct and modulating exhaust. High pressure blowers may be provided to supply air to a perforated plate. This may provide a high velocity of air across the product path. Air may be recirculated from both sides of the tunnel, for example.

The treatment apparatus can utilize the conveyor system for moving the items while a barrier film composition is applied to the items and/or while the items are subsequently dried. In some implementations, the conveyor system includes a conveyor bed configured to cause the items to simultaneously rotate as they move from one section to another, facilitating complete surface coverage and/or drying. Alternatively or additionally, the treatment apparatus can also include other components such as sprayers and/or blowers that directly treat and/or facilitate drying of the items while they are on the bed of the conveyor system. For example, one or more sprayers can be mounted over the bed and used to spray liquid droplets of solvent or solution on the items as the items passes the sprayers. The liquid droplets can, for example, include a sanitizing agent such as ethanol. The liquid droplets can alternatively include water, combinations of ethanol and water, or other solvents suitable for treatment of the items. As further described below, the liquid droplets can, for example, include a barrier film composition which forms a protective coating over the items on which it is sprayed. Alternatively, the sprayers can indirectly treat or coat the items by saturating rollers over which the items moves. The rollers can move independently from the belt or chain drive system that moves the conveyor, rotating the items, such that the rollers act to coat the items with the solution thereon. Additional features of application and drying systems are described in U.S. Provisional Application No. 63/104,600 which is incorporated by reference in its entirety.

In some embodiments, the deposited barrier film composition can have a thickness of less than about 100 microns, less than about 90 microns, less than about 80 microns, less than about 70 microns, less than about 60 microns, less than about 50 microns, less than about 40 microns, less than about 30 microns, less than about 20 microns, or less than about 10 microns.

In some embodiments, the deposited barrier film composition can have a thickness of less than about 2 microns, for example less than 1 micron, less than 900 nm, less than 800 nm, less than 700 nm, less than 600 nm, less than 500 nm, less than 400 nm, less than 300 nm, less than 200 nm, or less than 100 nm, such that the barrier film composition is transparent to the naked eye. The deposited barrier film composition can have a high degree of crystallinity to decrease permeability, such that the barrier film composition is conformally deposited over the plant matter and is free of defects and/or pinholes. In some embodiments, applying the barrier film composition to the plant matter comprises dipping the plant matter in the barrier film composition.

In some embodiments, the barrier film compositions can be deposited on an agricultural product such as plant matter by passing the agricultural products under a stream of the barrier film composition (e.g., a waterfall of the barrier film composition). For example, the plant matter can be disposed on a conveyor that passes through the stream of the barrier film composition. In some embodiments, the barrier film composition can be vapor deposited on the surface of the plant matter. In some embodiments, the barrier film composition can be applied in the field before harvest. In some embodiments, the barrier film composition is applied to the plant matter pre-harvest. In some embodiments, the barrier film composition can be applied to the plant matter after harvest (e.g., after the plant matter has been separated from where the majority of growth has taken place). In some embodiments, the barrier film composition is applied to the plant matter post-harvest.

In some embodiments, any of the barrier film compositions described herein can be spray coated on the plant matter. In some embodiments, applying the composition to the surface of the plant matter comprises spraying the barrier film composition on the surface of the plant matter. Commercially available sprayers can be used for spraying the barrier film composition onto the surface of the plant matter.

In some embodiments, the plant matter is an agricultural product such as a flower or produce (e.g., fresh produce). In some embodiments, the plant matter comprises or is selected from the group consisting of a fruit, a vegetable, a leaf, a stem, bark, a seed, a flower, and a combination thereof. In some embodiments, the plant matter is a flower. In some embodiments, the plant matter is fresh produce. In some embodiments, the plant matter is a vegetable. In some embodiments, the plant matter is a fruit.

In some embodiments, following the application of the barrier film composition to the plant matter, desiccation is reduced. In some embodiments, following application of the composition, the rate of water lost from the plant matter is reduced. In some embodiments, desiccation is measured with mass loss. In some embodiments, following the application of the composition, the rate of mass loss is reduced. In some embodiments, water loss is measured by mass loss. Mass loss, for example, can be measured by determining the difference between the weight of plant matter after application of the barrier film composition and after a certain amount of time passes. In some embodiments, mass loss is measured after 1 day, 2 days, 3 days, 4 days, 5 days, 6 days, 7, days, 8 days, 9 days, and/or 10 days or after any combination thereof. In some embodiments, mass loss is measured after 1 week, after 2 weeks, after 3 weeks, after 4 weeks, after 5 weeks, after 6 weeks, after 7 weeks, after 8 weeks, after 9 weeks, after 10 weeks, after 11 weeks, after 12 weeks, or after any combination thereof.

In some embodiments, following application of the barrier film composition the respiration rate of the plant matter can be reduced. For example, the application of any of the barrier film compositions described herein can be used to block or limit diffusion of gasses such as ethylene, CO₂, and O₂, among others, thereby slowing ripening and/or senescence. In some embodiments, following the application of the composition, the rate of CO₂ production by the plant matter is reduced.

### Plant Matter

Also provided herein is an agricultural product (e.g., plant matter) comprising any barrier film composition described herein. In some embodiments, a plant matter comprising any of the barrier film coatings described herein covers at least a portion of a surface of the plant matter. In some embodiments, any of the barrier film coatings described herein can cover at least a portion of plant matter plant matter comprises one or more of or is selected from the group consisting of a fruit, a vegetable, a leaf, a stem, bark, a seed, a flower, and a combination thereof. In some embodiments, the plant matter is a flower. In some embodiments, the plant matter is fresh produce. In some embodiments, the plant matter is a vegetable. In some embodiments, the plant matter is a fruit. In some embodiments, the plant matter is post-harvest. In some embodiments, the plant matter is pre-harvest. In some embodiments, the plant matter is a flower with any of the barrier films described herein applied to at least a portion of the surface of the flower. In some embodiments, the plant matter is a fruit with any of the barrier films described herein applied to at least a portion of the surface of the fruit. In some embodiments, the plant matter is a vegetable with any of the barrier films described herein applied to at least a portion of the surface of the vegetable.

In some embodiments, the barrier film composition is applied to at least a portion of the plant matter via dipping the plant matter into the barrier film composition. In some embodiments, the plant matter can be dip coated in a bath of the barrier film composition (e.g., an aqueous solution of hydrogen-bonding organic molecules). In some embodiments, applying the barrier film composition to the plant matter comprises dipping the plant matter in the barrier film composition.

In some embodiments, the composition can reduce the rate of CO₂ production by the plant matter. In some embodiments, the composition can reduce the consumption of O₂ by the plant matter. In some embodiments, the composition can reduce the rate of water loss by the plant matter. In some embodiments, the composition can reduce the rate of mass loss by the plant matter.

A number of embodiments of the invention have been described. Nevertheless, it will be understood that various modifications may be made without departing from the spirit and scope of the invention. Accordingly, other embodiments are within the scope of the following claims.

### EXAMPLES

The materials and methods of the disclosure will be further described in the following examples, which do not limit the scope of the methods and compositions of matter described in the claims.

### Example 1

Fifty grams of a mixture comprising a 1:1 molar ratio of L-arginine and cetyl dihydrogen phosphate was prepared (17.32 grams of L-arginine was combined with 32.46 grams of cetyl phosphate). The mixture was then added to 1 L of deionized water that had been heated to 80° C. and homogenized for 3 minutes at high speed in a VITAMIX® blender. The resulting dispersion was then used for coating on produce.

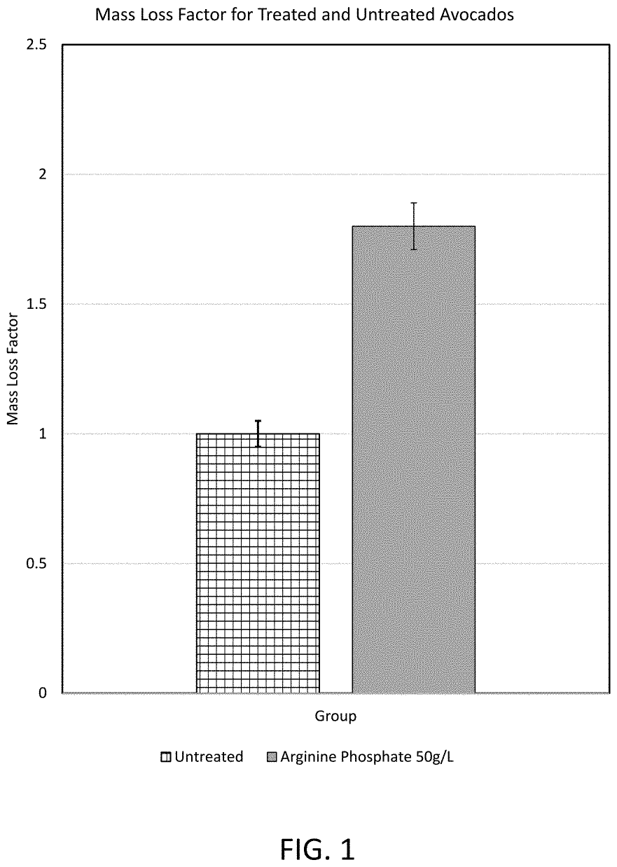

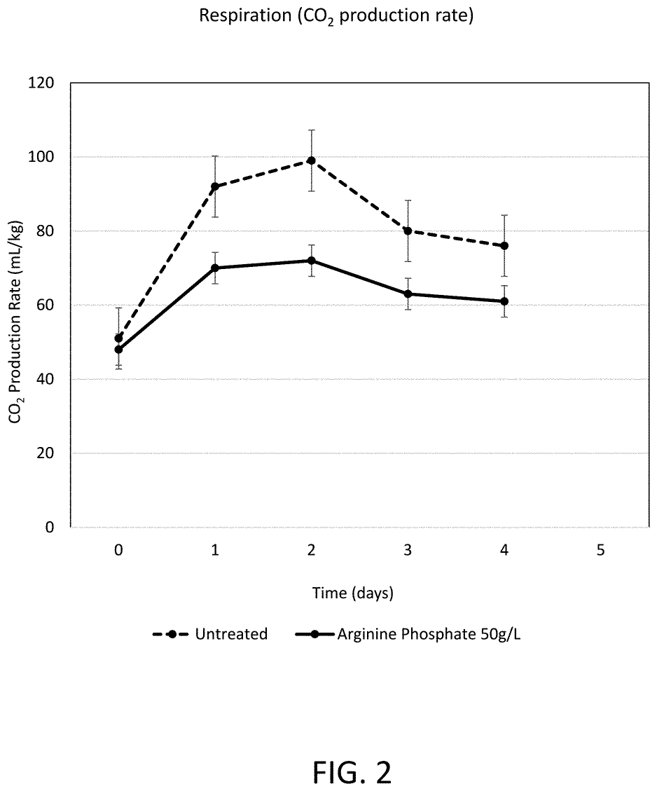

A coating experiment was conducted by dipping avocados in the coating solution. The avocados were then dried in a rolling, translating heat tunnel at 65-70° C. for 100 seconds. Ninety Mexican avocados of the same size, quality, ripeness, pack date and orchard were used in each group. Mass loss and respiration versus time were measured on these fruits. The same measurements were performed on a set of untreated fruits. The results of these experiments are shown in FIG. 1 and FIG. 2.

FIG. 1 is a plot of mass loss factor of treated (solid data) and untreated (non-solid data) avocados over a period of 5 days. Mass loss factor was determined by dividing the mass loss rate of the untreated control by the respective treatment values. Untreated (non-solid data) and treated (solid data) with 50 g/L of a 1:1 molar mixture of L-arginine and cetyl phosphate.

FIG. 2 is a plot of the respiration rate (CO₂ production rate) of treated (solid line) and untreated (broken line) avocados over a period of 5 days. It is clear from the results that the method of the invention provides a substantially higher mass loss factor and lower respiration rates compared to the untreated control.

### Example 2

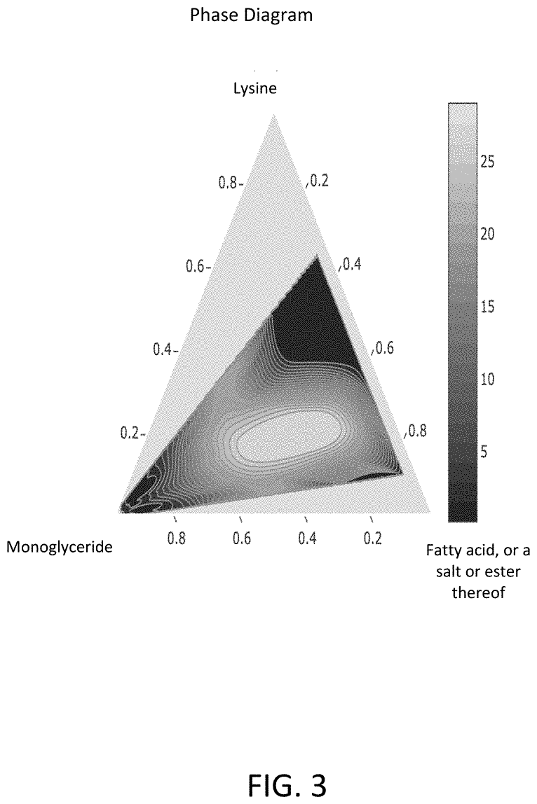

50 grams of a mixture comprising of 95% w/w glycerol monostearate (GMS) and 5% w/w L-lysine and stearic acid (L-lysine and stearic acid at a 1:1 molar ratio) was prepared. The mixture was then added to 1 L of deionized water that had been heated to 80C and homogenized for 3 minutes at high speed in a VITAMIX® blender. The resulting dispersion was then used for coating on produce. In addition to this ratio, the following phase diagram of FIG. 3 displays the dispersion stability (in days) for different compositions (wt fraction) of glycerol monostearate, stearic acid, and L-lysine.

A coating experiment was conducted by dipping avocados in the coating solutions (e.g., the barrier film compositions). The avocados were then dried in a rolling, translating tunnel at 65-70° C. for 100 seconds. One hundred twenty Californian avocados of the same size, quality, ripeness, pack data, and supplier were used in each group.

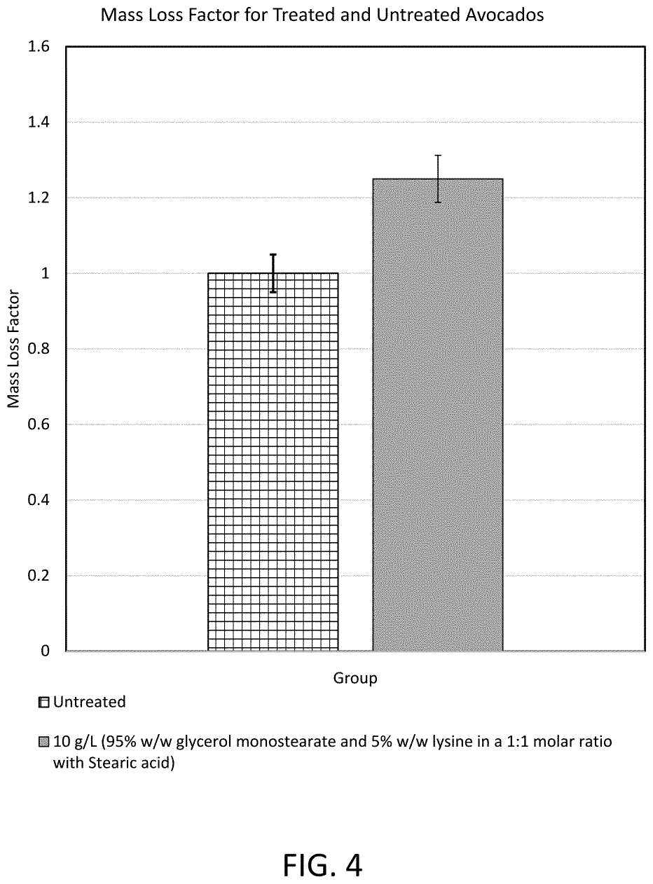

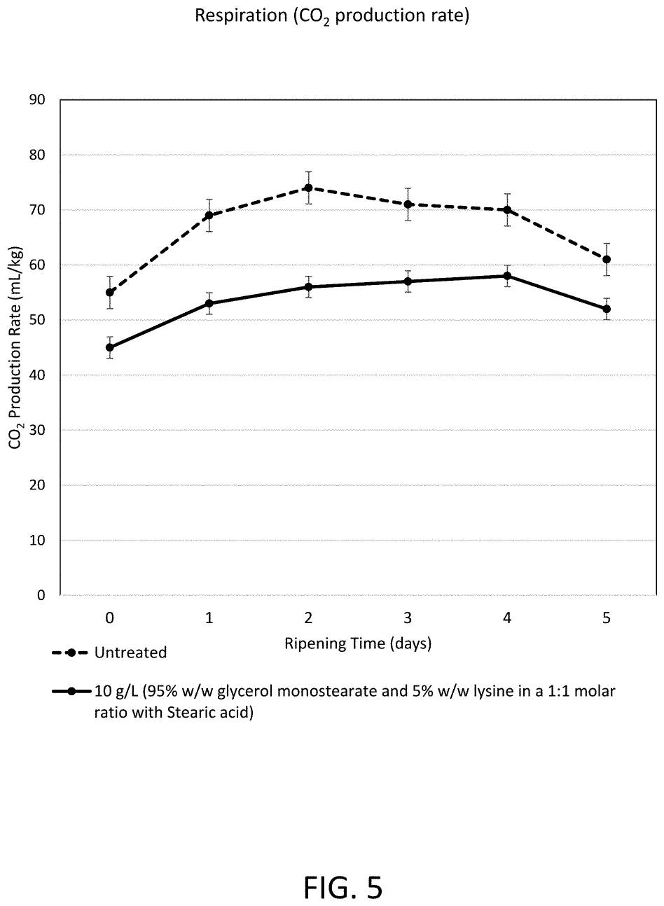

Mass loss and respiration versus time were measured on these fruits. The same measurements were performed on a set of untreated fruits. The results of the experiment are shown in FIG. 4 and FIG. 5.

FIG. 4 is a plot of mass loss factor of untreated avocados (non-solid data) and avocados treated with 10 g/L of 95% w/w glycerol monostearate and 5% w/w lysine in a 1:1 molar ratio with stearic acid (solid data) over a period of 5 days.

FIG. 5 is a plot of the CO₂ production rate of untreated avocados (broken line) and avocados treated with 10 g/L of 95% w/w glycerol monostearate and 5% w/w lysine in a 1:1 molar ratio with stearic acid (solid line) avocados over a period of 5 days. From the results, there is an advantage for the coated produce compared to untreated produce in terms of moisture retention and shelf life extension.

### Example 3

50 grams of a mixture comprising of 95% w/w glycerol monostearate (GMS) and 5% w/w of L-lysine was prepared. The mixture was then added to 1 L of deionized water that had been heated to 80° C. and homogenized for 3 minutes at high speed in a VITAMIX® blender. The resulting dispersion was then used for coating on produce.

A coating experiment was conducted by dipping avocados in the coating solutions. The avocados were then dried in a rolling, translating tunnel at 65-70° C. for 100 seconds. One hundred twenty Californian avocados of the same size, quality, ripeness, pack data, and supplier were used in each group.

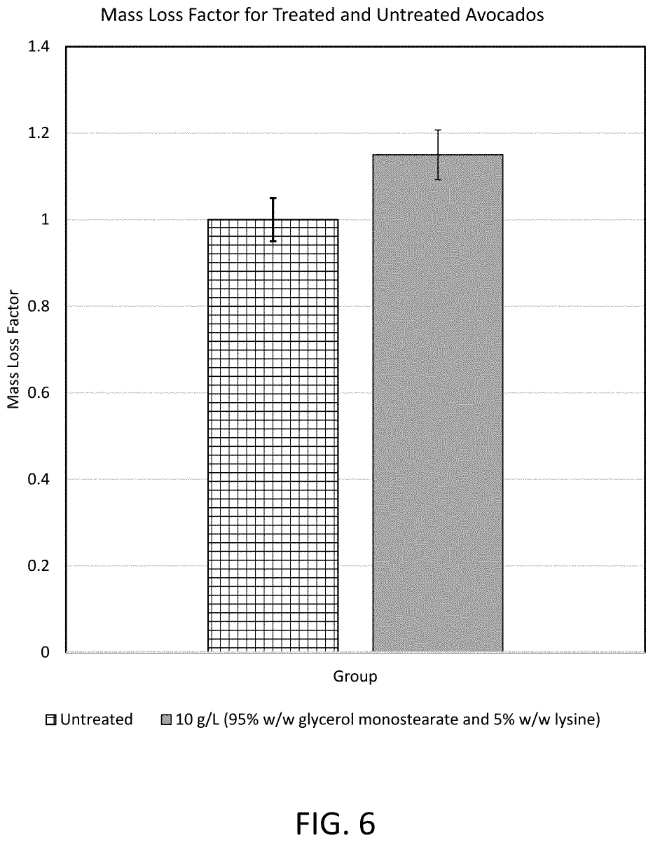

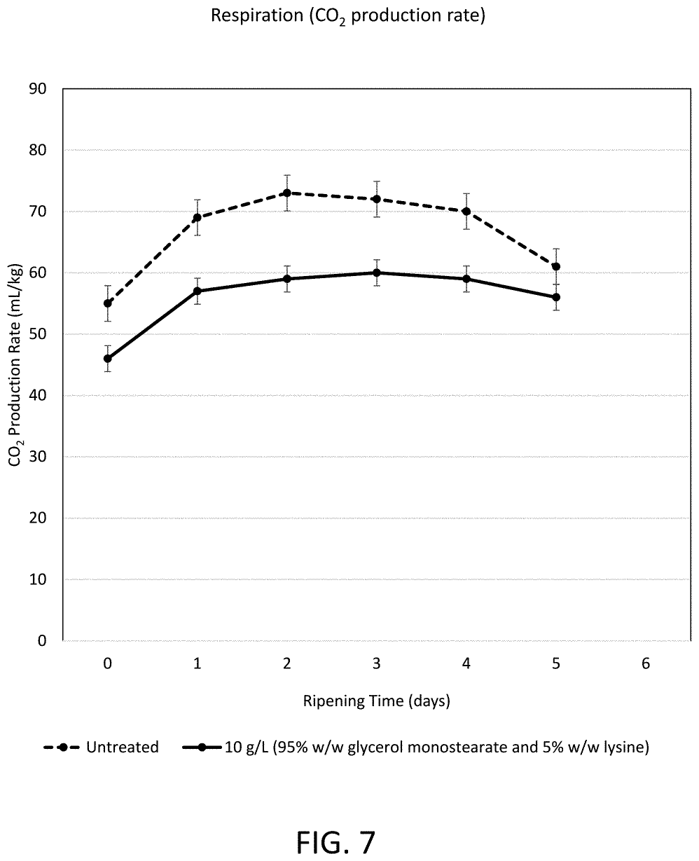

Mass loss and respiration versus time were measured on these fruits. The same measurements were performed on a set of untreated fruits. The results of the experiment are shown in FIG. 6 and FIG. 7.

FIG. 6 is a plot of mass loss factor of untreated avocados (non-solid data) and avocados treated with 10 g/L of 95% w/w glycerol monostearate and 5% w/w lysine (solid data) over a period of 5 days.

FIG. 7 is a plot of the CO₂ production rate of untreated avocados (broken line) and avocados treated with 10 g/L of 95% w/w glycerol monostearate and 5% w/w lysine (solid line) avocados over a period of 5 days. From the results of FIG. 6 and FIG. 7, there is an advantage for the coated produce compared to untreated produce in terms of moisture retention and shelf life extension.

### Embodiments

Embodiment 1 is a barrier film composition, comprising: a first component comprising a charged long chain alkyl; and a second component having an opposing charge, wherein the molar ratio of the first component to the second component is about 1:3 to about 3:1.

Embodiment 2 is the barrier film composition of embodiment 1, wherein the charged long chain alkyl is a long chain phosphate.

Embodiment 3 is the barrier film composition of embodiment 1, wherein the charged long chain alkyl is a fatty acid.

Embodiment 4 is the barrier film composition of any one of embodiments 1-3, wherein the second component is a charged amino acid.

Embodiment 5 is the barrier film composition of embodiment 5, wherein the charged amino acid is positively charged.

Embodiment 6 is the barrier film composition of any one of embodiments 1-3, wherein the second component is selected from the group consisting of L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, and a combination thereof.

Embodiment 7 is the barrier film composition of embodiment 6, wherein the second component is selected from the group consisting of L-arginine, L-lysine, L-histidine, and a combination thereof.

Embodiment 8 is the barrier film composition of any one of embodiments 1-7, wherein the first component has a carbon length of 12 carbons to 20 carbons.

Embodiment 9 is the barrier film composition of any one of embodiments 1-8, wherein the first component is a charged C12 alkyl, a charged C14 alkyl, a charged C16 alkyl, a charged C18 alkyl, a charged C20 alkyl, a charged C22 alkyl, a charged C24 alkyl, a charged C26 alkyl, a charged C28 alkyl, a charged C30 alkyl, or a combination thereof.

Embodiment 10 is the barrier film composition of embodiment 3, wherein the fatty acid is a C12 fatty acid, a C14 fatty acid, a C16 fatty acid, a C18 fatty acid, a C20 fatty acid, a C22 fatty acid, a C24 fatty acid, a C26 fatty acid, a C28 fatty acid, a C30 fatty acid, and a combination thereof.

Embodiment 11 is the barrier film composition of embodiment 3 or embodiment 10, wherein the fatty acid is a saturated fatty acid.

Embodiment 12 is the barrier film composition of any one of embodiments 3, 10, or 11 wherein the fatty acid is selected from the group consisting of lauric acid, myristic acid, palmitic acid, stearic acid, arachidic acid, oleic acid, and a combination thereof.

Embodiment 13 is the barrier film composition of embodiment 12, wherein the fatty acid is stearic acid.

Embodiment 14 is the barrier film composition of any one of embodiments 1-13, wherein the molar ratio of the first component to the second component is about 1:1.

Embodiment 15 is the barrier film composition of any one of embodiments 1-13, wherein the molar ratio of the first component to the second component is about 1:2.

Embodiment 16 is the barrier film composition of any one of embodiments 1-13, wherein the molar ratio of the first component to the second component is about 1:3.

Embodiment 17 is the barrier film composition of any one of embodiments 1-13, wherein the molar ratio of the first component to the second component is about 2:1.

Embodiment 18 is the barrier film composition of any one of embodiments 1-13, wherein the molar ratio of the first component to the second component is about 3:1.

Embodiment 19 is the barrier film composition of embodiment 2, wherein the long chain phosphate is selected from the group consisting of monoalkyl phosphate, dialkyl phosphate, and hydrogen phosphate and combinations thereof.

Embodiment 20 is the barrier film composition of embodiment 1, wherein the charged long chain alkyl is a long chain phosphonate.

Embodiment 21 is the barrier film composition of embodiment 20, wherein the long chain phosphonate is selected from the group consisting of a phosphonate, hydrogen phosphonate, and alkyl phosphonate.

Embodiment 22 is the barrier film composition of any one of embodiments 1-21, further comprising a nonionic amphiphile.

Embodiment 23 is the barrier film composition of embodiment 22, wherein the nonionic amphiphile has a carbon length selected from the group consisting of a C10 nonionic amphiphile, a C12 nonionic amphiphile, a C14 nonionic amphiphile, a C16 nonionic amphiphile, a C18 nonionic amphiphile, a C20 nonionic amphiphile, or a combination thereof.

Embodiment 24 is the barrier film composition of embodiment 22 or embodiment 23, wherein the nonionic amphiphile is a monoglyceride.

Embodiment 25 is the barrier film composition of any one of embodiments 23-24, wherein the nonionic amphiphile is a saturated monoglyceride.

Embodiment 26 is the barrier film composition of any one of embodiments 1-25, further comprising water.

Embodiment 27 is a barrier film composition, comprising a first component comprising a nonionic amphiphile; and a second component having a charge; wherein the second component is about 1% w/v to about 15% w/v of the barrier film composition.

Embodiment 28 is the barrier film composition of embodiment 27, wherein the second component is about 3% w/v of the barrier film composition.

Embodiment 29 is the barrier film composition of embodiment 27, wherein the second component is about 5% w/v of the barrier film composition.

Embodiment 30 is the barrier film composition of embodiment 27, wherein the second component is about 7% w/v of the barrier film composition.

Embodiment 31 is the barrier film composition of embodiment 27, wherein the second component is about 10% w/v of the barrier film composition.

Embodiment 32 is the barrier film composition of any one of embodiments 27-31, wherein the nonionic amphiphile has a carbon length selected from the group consisting of a C10 nonionic amphiphile, a C12 nonionic amphiphile, a C14 nonionic amphiphile, a C16 nonionic amphiphile, a C18 nonionic amphiphile, a C20 nonionic amphiphile, or a combination thereof.

Embodiment 33 is the barrier film composition of any one of embodiments 27-32, wherein the nonionic amphiphile is a monoglyceride.

Embodiment 34 is the barrier film composition of any one of embodiments 27-33, wherein the nonionic amphiphile is a saturated monoglyceride.

Embodiment 35 is the barrier film composition of any one of embodiments 1-34, wherein the second component is selected from the group consisting of L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, and a combination thereof.

Embodiment 36 is the barrier film composition of any one of embodiments 27-34, wherein the second component is a charged amino acid.

Embodiment 37 is the barrier film composition of embodiment 36, wherein the charged amino acid is positively charged.

Embodiment 38 is the barrier film composition of embodiment 37, wherein the second component is selected from the group consisting of L-arginine, L-lysine, L-histidine, and a combination thereof.

Embodiment 39 is the barrier film composition of any one of embodiments 27-38, wherein the second component is L-arginine.

Embodiment 40 is the barrier film composition of any one of embodiments 27-38, wherein the second component is L-lysine.

Embodiment 41 is the barrier film composition of any one of embodiments 27-38, wherein the second component is L-histidine.

Embodiment 42 is the barrier film composition of any one of embodiments 1-41, wherein the composition further comprises an additive.

Embodiment 43 is the barrier film composition of embodiment 42, wherein the additive is selected from the group consisting of a preservative, a vitamin, a mineral, a pH modifier, a pigment, a fragrance, an enzyme, a catalyst, an anti-oxidant, an antifungal, an antimicrobial, or a combination thereof.

Embodiment 44 is a method of making a barrier film composition, the method comprising: combining a first component comprising a charged long chain alkyl, a second component having an opposing charge, and water to form an aqueous dispersion.

Embodiment 45 is the method of embodiment 44, wherein the charged long chain alkyl is a long chain phosphate.

Embodiment 46 is the method of embodiment 45, wherein the charged long chain alkyl is a fatty acid.

Embodiment 47 is the method of any one of embodiments 44-46, wherein the first component has a carbon length of 12 carbons to 20 carbons.

Embodiment 48 is the method of any one of embodiments 43-46, wherein the first component is a charged C12 alkyl, a charged C14 alkyl, a charged C16 alkyl, a charged C18 alkyl, a charged C20 alkyl, a charged C22 alkyl, a charged C24 alkyl, a charged C26 alkyl, a charged C28 alkyl, a charged C30 alkyl, or a combination thereof.

Embodiment 49 is the method of embodiment 46, wherein the fatty acid is a C12 fatty acid, a C14 fatty acid, a C16 fatty acid, a C18 fatty acid, a C20 fatty acid, a C22 fatty acid, a C24 fatty acid, a C26 fatty acid, a C28 fatty acid, a C30 fatty acid, and a combination thereof.

Embodiment 50 is the method of embodiment 46 or embodiment 49, wherein the fatty acid is a saturated fatty acid.

Embodiment 51 is the method of any one of embodiments 46, 49, or 50, wherein the fatty acid is selected from the group consisting of lauric acid, myristic acid, palmitic acid, stearic acid, arachidic acid, oleic acid, and a combination thereof.

Embodiment 52 is the method of embodiment 51, wherein the fatty acid is stearic acid.

Embodiment 53 is the method of any one of embodiments 44-53, wherein the second component is a charged amino acid.

Embodiment 54 is the method of embodiment 53, wherein the charged amino acid is positively charged.

Embodiment 55 is the method of any one of embodiments 44-52, wherein the second component is selected from the group consisting of L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, and a combination thereof.

Embodiment 56 is the method of any one of embodiments 44-55, wherein the second component is selected from the group consisting of L-arginine, L-lysine, L-histidine, and a combination thereof.

Embodiment 57 is the method of any one of embodiments 44-56, further comprising combining a nonionic amphiphile with the first component and the second component.

Embodiment 58 is the method of embodiment 57, wherein the nonionic amphiphile is a monoglyceride.

Embodiment 59 is the method of any one of embodiment 56 or embodiment 58, wherein the nonionic amphiphile is a saturated monoglyceride.

Embodiment 60 is the method of any one of embodiments 44-59, wherein combining comprises blending the first component and the second component with the water for a period of time of about 1 minute to about 4 minutes.

Embodiment 61 is the method of embodiment 60, wherein combining comprises blending the first component and the second component with the water for a period of time of about 3 minutes.

Embodiment 62 is the method of any one of embodiments 44-61, wherein combining comprises heating the water to a temperature of about 70° C. to about 90° C.

Embodiment 63 is the method of embodiment 62, wherein combining comprises heating the water to a temperature of about 80° C.

Embodiment 64 is a method of making a barrier film, the method comprising combining a first component comprising a nonionic amphiphile, a second component having a charge, and water to form an aqueous dispersion.

Embodiment 65 is the method of embodiment 64, wherein the nonionic amphiphile has a carbon length selected from the group consisting of a C10 nonionic amphiphile, a C12 nonionic amphiphile, a C14 nonionic amphiphile, a C16 nonionic amphiphile, a C18 nonionic amphiphile, a C20 nonionic amphiphile, or a combination thereof.

Embodiment 66 is the method of embodiment 64 or embodiment 65, wherein the nonionic amphiphile is a monoglyceride.

Embodiment 67 is the method of any one of embodiments 64-66, wherein the nonionic amphiphile is a saturated monoglyceride.

Embodiment 68 is the method of any one of embodiments 64-67, wherein the second component is a charged amino acid.

Embodiment 69 is the method of embodiment 68, wherein the charged amino acid is positively charged.

Embodiment 70 is the method of any one of embodiments 64-67, wherein the second component is selected from the group consisting of L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, and a combination thereof.

Embodiment 71 is the method of any one of embodiments 65-70, wherein the second component is selected from the group consisting of L-arginine, L-lysine, L-histidine, and a combination thereof.

Embodiment 72 is the method of any one of embodiments 65-71, wherein combining comprises blending first component and the second component with the water for a period of time of about 1 minute to about 4 minutes.

Embodiment 73 is the method of embodiment 72, wherein forming the combining comprises blending the first component and the second component with the water for a period of time of about 3 minutes.

Embodiment 74 is the method of any one of embodiments 64-73, wherein combining comprises heating the water to a temperature of about 70° C. to about 90° C.

Embodiment 75 is the method of embodiment 74, wherein combining comprises heating the water to a temperature of about 80° C.

Embodiment 76 is a method of coating plant matter, the method comprising applying the aqueous dispersion of any one of embodiments 44-75 to the surface of plant matter.

Embodiment 77 is the method of embodiment 76, wherein applying the composition to the surface of the plant matter comprises dipping the plant matter in the composition.

Embodiment 78 is the method of embodiment 76, wherein applying the composition to the surface of the plant matter comprises spraying the composition on the surface of the plant matter.

Embodiment 79 is the method of any one if embodiments 76-78, further comprising allowing the composition to at least partially evaporate for a period time of about 30 seconds to about 180 seconds after applying to the plant matter.

Embodiment 80 is the method of embodiment 79, wherein the period of time is about 100 seconds.

Embodiment 81 is the method of any one of embodiments 76-80, wherein the plant matter is selected from the group consisting of a fruit, a vegetable, a leaf, a stem, bark, a seed, a flower, and a combination thereof.

Embodiment 82 is a method of forming a barrier film on plant matter, the method comprising applying a barrier film composition of any one of embodiments 1-42 to a surface of the plant matter.

Embodiment 83 is the method of embodiment 82, wherein applying the composition to a surface of the plant matter comprises dipping the plant matter in the composition.

Embodiment 84 is the method of embodiment 82, wherein applying the composition to a surface of the plant matter comprises spraying the composition on the surface of the plant matter.

Embodiment 85 is the method of any one of embodiments 82-84, further comprising allowing the composition to at least partially evaporate for a period time of about 30 seconds to about 180 seconds after applying to the plant matter.

Embodiment 86 is the method of embodiment 85, wherein the period of time is about 100 seconds.

Embodiment 87 is the method of any one of embodiments 82-86, further comprising homogenizing the composition prior to applying to the plant matter.

Embodiment 88 is the method of embodiment 87, wherein the composition is homogenized in a blender for a period of time of about 1 minute to about 4 minutes.

Embodiment 89 is the method of any one of embodiments 80-88, wherein following the application of the composition, the rate of water loss from the plant matter is reduced.

Embodiment 90 is the method of any one of embodiments 80-89, wherein following the application of the composition, the rate of CO2 production by the plant matter is reduced.

Embodiment 91 is the method of any one of embodiments 80-90, wherein following the application of the composition, the rate of mass loss of the plant matter is reduced.

Embodiment 92 is the method of any one of embodiments 80-91, wherein the plant matter is selected from the group consisting of a fruit, a vegetable, a leaf, a stem, bark, a seed, a flower, and a combination thereof.

Embodiment 93 is the method of any one of embodiments 80-92, wherein the composition is applied to the plant matter pre-harvest.

Embodiment 94 is the method of any one of embodiments 80-93, wherein the composition is applied to the plant matter post-harvest.

Embodiment 95 is a coated plant matter comprising a barrier film composition of any one of embodiments 1-43, wherein the barrier film composition covers at least a portion of a surface of the plant matter.

Embodiment 96 is the coated plant matter of embodiment 95, wherein the composition reduces the rate of water loss from the plant matter.

Embodiment 97 is the coated plant matter of embodiment 95 or embodiment 96, wherein the composition reduces the rate of CO2 production by the plant matter.

Embodiment 98 is the coated plant matter of any one of embodiments 95-97, wherein the composition reduces the rate of mass loss of the plant matter.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A barrier film composition, comprising:
a first component has a first ionic charge and a carbon chain length of C12 to C30; and
a second component has a second ionic charge opposite in sign to the first ionic charge, wherein a molar ratio of the first component to the second component is about 1:3 to about 3:1.

2. The barrier film composition of claim 1, wherein the first component is a phosphate.

3. The barrier film composition of claim 2, wherein the phosphate comprises monoalkyl phosphate, dialkyl phosphate, or combinations thereof.

4. The barrier film composition of claim 2, wherein the first component is a fatty acid.

5. The barrier film composition of claim 4, wherein the fatty acid comprises lauric acid, myristic acid, palmitic acid, stearic acid, arachidic acid, oleic acid, or a combination thereof.

6. The barrier film composition of 1, wherein the second component comprises L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, or a combination thereof.

7. The barrier film composition of claim 1, wherein the second component is a positively charged amino acid.

8. The barrier film composition of claim 1, further comprising a nonionic amphiphile having a carbon chain length of C12 to C30.

9. The barrier film composition of claim 8, wherein the nonionic amphiphile comprises a monoglyceride.

10. A barrier film composition, comprising:
a first component comprises a nonionic amphiphile having a carbon chain length of C10-C20; and
a second component has an ionic charge, wherein the barrier film composition comprises about 1% w/v to about 15% w/v of the second component.

11. The barrier film composition of claim 10, wherein the first component comprises a monoglyceride.

12. The barrier film composition of claim 10, wherein the second component comprises L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, or a combination thereof.

13. The barrier film composition of claim 10, wherein the second component is an ionically charged amino acid.

14. A method of making a barrier film composition, comprising:
combining a first component having a first ionic charge and a carbon chain length of C12 to C30, a second component having a second ionic charge opposite in sign to the first ionic charge, and water to form an aqueous dispersion, wherein a molar ratio of the first component to the second component is about 1:3 to about 3:1.

15. The method of claim 14, wherein the first component is a phosphate.

16. The method of claim 15, wherein the phosphate comprises monoalkyl phosphate, dialkyl phosphate, and hydrogen phosphate or combinations thereof.

17. The method of claim 14, wherein the first component is a fatty acid.

18. The method of claim 17, wherein the fatty acid comprises lauric acid, myristic acid, palmitic acid, stearic acid, arachidic acid, oleic acid, or a combination thereof.

19. The method of claim 14, wherein the second component comprises L-arginine, L-histidine, L-lysine, guanidine, choline hydroxide, betaine, diethanolamine, glutamic acid and salts thereof, fumaric acid and salts thereof, a-ketoglutaric acid and salts, L-ornithine and salts, pyruvic acid and salts thereof, or a combination thereof.

20. The method of claim 19, wherein the second component is a positively charged amino acid.
